(19) United States
(12) Patent Application Publication
(10) Pub. No.: US 2023/0071513 A1
(43) Pub. Date: Mar. 9, 2023

(54) PRINT HEAD AND METHOD FOR ADDITIVE MANUFACTURING SYSTEM

(71) Applicant: Continuous Composites Inc., Coeur D'Alene, ID (US)

(72) Inventors: Andrew John Overby, Coeur d'Alene, ID (US); Nathan Andrew Stranberg, Post Falls, ID (US); Stephen Tyler Wilson, Coeur D'Alene, ID (US); Sam Armstrong, Coeur d'Alene, ID (US); Maxwell Joseph Johnson, Hayden, ID (US); Samuel VanDenBerg, Hayden, ID (US)

(73) Assignee: Continuous Composites Inc., Coeur D'Alene, ID (US)

(21) Appl. No.: 17/929,663

(22) Filed: Sep. 2, 2022

Related U.S. Application Data
(60) Provisional application No. 63/268,044, filed on Feb. 15, 2022.
(60) Provisional application No. 63/265,827, filed on Dec. 21, 2021.
(60) Provisional application No. 63/260,919, filed on Sep. 4, 2021.

(51) Int. Cl. B29C 64/209; B33Y 10/00; B33Y 30/00; B33Y 50/02; B29C 64/165; B29C 64/393

(52) U.S. Cl. CPC B29C 64/209; B33Y 10/00; B33Y 30/00; B33Y 50/02; B29C 64/165; B29C 64/393; B29K 2105/08

(57) ABSTRACT

A system is disclosed for additively manufacturing an object. The system may include a support, and a print head operatively connected to and moveable by the support. The print head may include a supply module configured to hold a reinforcement, and a wetting module. The wetting module may include a body with an inlet configured to separately receive the reinforcement and a matrix, and an outlet configured to discharge the reinforcement wetted with the matrix. The print head may also include a teasing mechanism disposed between the inlet and the outlet. The teasing mechanism may have multiple operating positions configured to affect varying levels of pressure against the reinforcement.

### RELATED APPLICATION

This application is based on and claims the benefit of priority from U.S. Provisional Applications Nos. 63/260,919, 63/265,827 and 63/268,044 that were filed on Sep. 4, 2021, Dec. 21, 2021 and Feb. 15, 2022, respectively, the contents of all of which are expressly incorporated herein by reference.

### TECHNICAL FIELD

The present disclosure relates generally to a manufacturing system and, more particularly, to a print head and method for an additive manufacturing system.

### BACKGROUND

Continuous fiber 3D printing (a.k.a., CF3D®) involves the use of continuous fibers embedded within material discharging from a moveable print head. A matrix is supplied to the print head and discharged (e.g., extruded and/or pultruded) along with one or more continuous fibers also passing through the same print head at the same time. The matrix can be a traditional thermoplastic, a liquid thermoset (e.g., an energy-curable single- or multi-part resin), or a combination of any of these and other known matrixes. Upon exiting the print head, a cure enhancer (e.g., a UV light, a laser, an ultrasonic emitter, a heat source, a catalyst supply, or another energy source) is activated to initiate, enhance, and/or complete curing (e.g., cross-linking and/or hardening) of the matrix. This curing occurs almost immediately, allowing for unsupported structures to be fabricated in free space. When fibers, particularly continuous fibers, are embedded within the structure, a strength of the structure can be multiplied beyond the matrix-dependent strength. An example of this technology is disclosed in U.S. Pat. No. 9,511,543 that issued to TYLER on Dec. 6, 2016.

Although CF3D® provides for increased strength, compared to manufacturing processes that do not utilize continuous fiber reinforcement, care should be taken to ensure proper wetting of the fibers with the matrix, proper cutting of the fibers, automated restarting after cutting, proper compaction of the matrix-coated fibers after discharge, and proper curing of the compacting material. Exemplary print heads that provide for at least some of these functions are disclosed in U.S. Patent Application Publication 2021/0260821 that was filed on Feb. 24, 2021 (“the '8215 publication”) and in U.S. patent application Ser. No. 17/443,421 that was filed on Jul. 26, 2021 (“the '421 application”), both of which are incorporated herein by reference.

While the print heads of the 821 publication and the '421 application may be functionally adequate for many situations, they may be less than optimal. For example, the print heads may lack accuracy in wetting, placement, cutting, compaction, curing and/or control that is required for other situations. The disclosed print heads, methods and systems are directed at addressing one or more of these issues and/or other problems of the prior art.

### SUMMARY

In one aspect, the present disclosure is directed to a system for additively manufacturing an object. The system may include a support and a print head operatively connected to and moveable by the support. The print head may include a supply module configured to hold a reinforcement, and a wetting module. The wetting module may include a body with an inlet configured to separately receive the reinforcement and a matrix, and an outlet configured to discharge the reinforcement wetted with the matrix. The print head may also include a teasing mechanism disposed between the inlet and the outlet. The teasing mechanism may have multiple operating positions configured to affect varying levels of pressure against the reinforcement.

In another aspect, the present disclosure is directed to a method of additively manufacturing a structure. The method may include pressurizing a matrix at a supply, and directing the pressurized matrix from the supply to an outlet that is remote from the supply. The method may also include detecting a pressure at the outlet, and adjusting a pressure at the supply based on the pressure at the outlet. The method may further include making a comparison of the pressure at the outlet to an expected pressure, and determining a characteristic of the matrix based on the comparison.

### BRIEF DESCRIPTION OF THE DRAWINGS

FIG. 1 is a diagrammatic illustration of an exemplary disclosed additive manufacturing system;

FIGS. 2, 3, 4 and 5 are diagrammatic illustrations of an exemplary disclosed print head (head) that may be utilized with the additive manufacturing system of FIG. 1;

FIGS. 6A, 6B, 7, 8, 9 and 10 are cross-sectional and/or diagrammatic illustrations of exemplary disclosed reinforcement supply, tensioning, matrix supply, and compacting/curing modules that may be used in conjunction with the head of FIGS. 2-5;

FIGS. 11 and 12 are diagrammatic illustrations of exemplary portions of the head of FIGS. 2-5;

FIGS. 13, 14, 15, 16, 17, 18, 19, 20 and 21 are cross-sectional and/or diagrammatic illustrations of an exemplary disclosed wetting module that may be used in conjunction with the head of FIGS. 2-5;

FIGS. 22, 23, 24, 25, 26, 27, 28, 29, 30, 31 and 32 are cross-sectional and/or diagrammatic illustrations of exemplary disclosed components of the wetting module of FIGS. 13-21;

FIGS. 33, 34 and 35 are cross-sectional and diagrammatic illustrations of another exemplary disclosed wetting module that may be used in conjunction with the head of FIGS. 2-5;

FIGS. 36 and 37 are cross-sectional illustrations of exemplary disclosed components of the wetting module of FIGS. 33-35;

FIGS. 38, 39, 40, 41, 42, 43, 44, 45, 46, 47, 48, 49, 50, 51, 52, 53, 54, 55, 56, 57, 58, 59, 60, 61, 62 and 63 are cross-sectional and/or diagrammatic illustrations of an exemplary disclosed compacting/curing module that may be used in conjunction with the head of FIGS. 2-5;

FIG. 64 is a diagram illustrating exemplary disclosed operations that may be performed by the additive manufacturing system of FIG. 1;

FIGS. 65, 66 and 67 are cross-sectional and/or diagrammatic illustrations of an exemplary disclosed compacting/curing module that may be used in conjunction with the head of FIGS. 2-5;

FIGS. 68, 69, 70 and 71 are diagrammatic illustrations of exemplary portions of the head of FIGS. 2-5; and

FIGS. 72, 73 and 74 are diagrammatic illustrations of exemplary disclosed processes that may be performed by the additive manufacturing system of FIG. 1.

### DETAILED DESCRIPTION

The term “about” as used herein serves to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

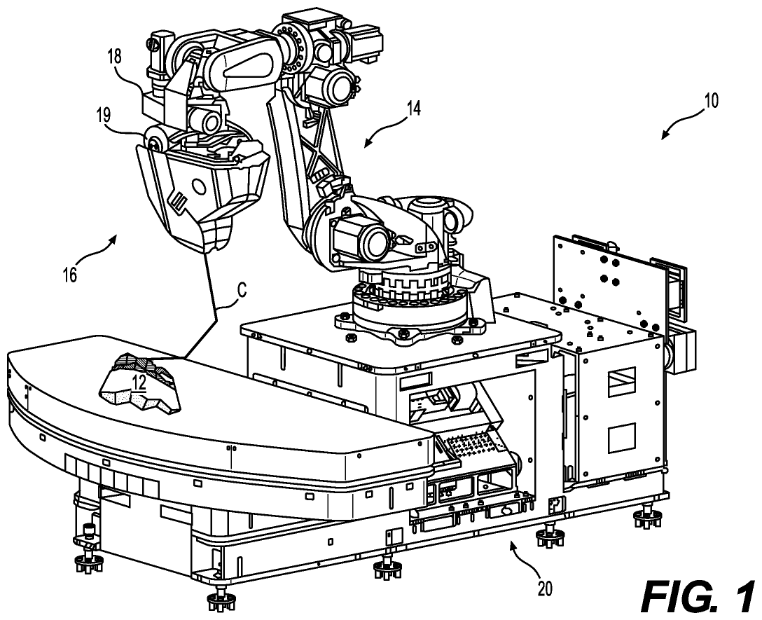

FIG. 1 illustrates an exemplary system 10, which may be used to manufacture a composite structure 12 having any desired shape, size, configuration, and/or material composition. System 10 may include at least a support 14 and a print head (“head”) 16. Head 16 may be coupled to and moveable by support 14 during discharge of a composite material (shown as C). In the disclosed embodiment of FIG. 1, support 14 is a robotic arm capable of moving head 16 in multiple directions during fabrication of structure 12. Support 14 may alternatively embody a gantry (e.g., a floor gantry, an overhead or bridge gantry, a single-post gantry, etc.) or a hybrid gantry/arm also capable of moving head 16 in multiple directions during fabrication of structure 12. Although support 14 is shown as being capable of 6-axis movements of head 16, it is contemplated that another type of support 14 capable of moving head 16 (and/or other tooling relative to head 16) in the same or a different manner could also be utilized. In some embodiments, a drive or coupler 18 may mechanically join head 16 to support 14 and include components that cooperate to move portions of and/or supply power and/or materials to head 16.

Head 16 may be configured to receive or otherwise contain a matrix that, together with a continuous reinforcement (e.g., with or without other additives or fillers), makes up the composite material C discharging from head 16. The matrix may include any type of material that is curable (e.g., a liquid resin, such as a zero-volatile organic compound resin, a powdered metal, etc.). Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized, for example by an external device (e.g., by an extruder or another type of pump—not shown) that is fluidly connected to head 16 via a corresponding conduit (not shown). In another embodiment, however, the pressure may be generated completely inside of head 16 by a similar type of device (discussed in more detail below). In yet other embodiments, the matrix may be gravity-fed into and/or through head 16. For example, the matrix may be fed into head 16 and pushed or pulled out of head 16 along with one or more continuous reinforcements. In some instances, the matrix inside head 16 may benefit from being kept cool, dark, and/or pressurized (e.g., to inhibit premature curing or otherwise obtain a desired rate of curing after discharge). In other instances, the matrix may need to be kept warm and/or light for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, ribbons, socks, sheets and/or tapes of continuous material) and, together with the reinforcements, make up a portion (e.g., a wall) of composite structure 12. The reinforcements may be stored within (e.g., on one or more separate internal creels 19) or otherwise passed through head 16 (e.g., fed from one or more external spools—not shown). When multiple reinforcements are simultaneously used, the reinforcements may be of the same material composition and have the same sizing and cross-sectional shape (e.g., circular, square, rectangular, etc.), or of a different material composition with different sizing and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers, particles, nanotubes, etc.) may be mixed with the matrix before and/or after the matrix coats the continuous reinforcements.

As will be explained in more detail below, one or more cure enhancers (e.g., a UV light, an ultrasonic emitter, a laser, a heater, a catalyst dispenser, and/or another source of cure energy) may be mounted proximate (e.g., within, on, or adjacent) head 16 and configured to enhance a cure rate and/or quality of the matrix as it discharges from head 16. The cure enhancer(s) may be controlled to selectively expose portions of structure 12 to the cure energy (e.g., to UV light, electromagnetic radiation, vibrations, heat, a chemical catalyst, etc.) during material discharge and the formation of structure 12. The cure energy may trigger a chemical reaction to occur within the matrix, increase a rate of the chemical reaction, sinter the matrix, harden the matrix, or otherwise cause the matrix to cure as it discharges from head 16. The amount of energy produced by the cure enhancer(s) may be sufficient to cure the matrix before structure 12 axially grows more than a predetermined length away from head 16. In one embodiment, structure 12 is at least partially cured before the axial growth length becomes equal to a cross-sectional dimension of the matrix-coated reinforcement.

The matrix and/or reinforcement may be discharged from head 16 via one or more different modes of operation. In a first exemplary mode of operation, the matrix and/or reinforcement are extruded (e.g., pushed under pressure and/or mechanical force) from head 16 as head 16 is moved by support 14 to create the 3-dimensional trajectory within a longitudinal axis of the discharging material. In a second exemplary mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is pulled from head 16 with the reinforcement, the resulting tension in the reinforcement may increase a strength of structure 12 (e.g., by aligning the reinforcements, inhibiting buckling, disbursing loading, etc.), while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a table, a floor, a wall, an existing surface of structure 12, etc.). For example, at the start of structure formation, a length of matrix-impregnated reinforcement may be pulled and/or pushed from head 16, deposited against the anchor, and at least partially cured, such that the discharged material adheres (or is otherwise coupled) to the anchor. Thereafter, head 16 may be moved away from the anchor (e.g., via controlled regulation of support 14), and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor, such that tension is created within the reinforcement. It is contemplated that the anchor could be moved away from head 16 instead of or in addition to head 16 being moved away from the anchor.

A controller 20 may be provided and communicatively coupled with support 14, head 16, and any number of the cure enhancer(s). Each controller 20 may embody a single processor or multiple processors that are specially programmed or otherwise configured via software and/or hardware to control an operation of system 10. Controller 20 may further include or be associated with a memory for storing data such as, for example, design limits, performance characteristics, operational instructions, tool paths, and corresponding parameters of each component of system 10. Various other known circuits may be associated with controller 20, including power supply circuitry, signal-conditioning circuitry, solenoid driver circuitry, communication circuitry, and other appropriate circuitry. Moreover, controller 20 may be capable of communicating with other components of system 10 via wired and/or wireless transmission.

One or more maps may be stored in the memory of controller 20 and used by controller 20 during fabrication of structure 12. Each of these maps may include a collection of data in the form of lookup tables, graphs, and/or equations. In the disclosed embodiment, controller 20 may be specially programmed to reference the maps and determine movements/operations of head 16 required to produce the desired size, shape, and/or contour of structure 12, and to responsively coordinate operation of support 14, the cure enhancer(s), and other components of head 16.

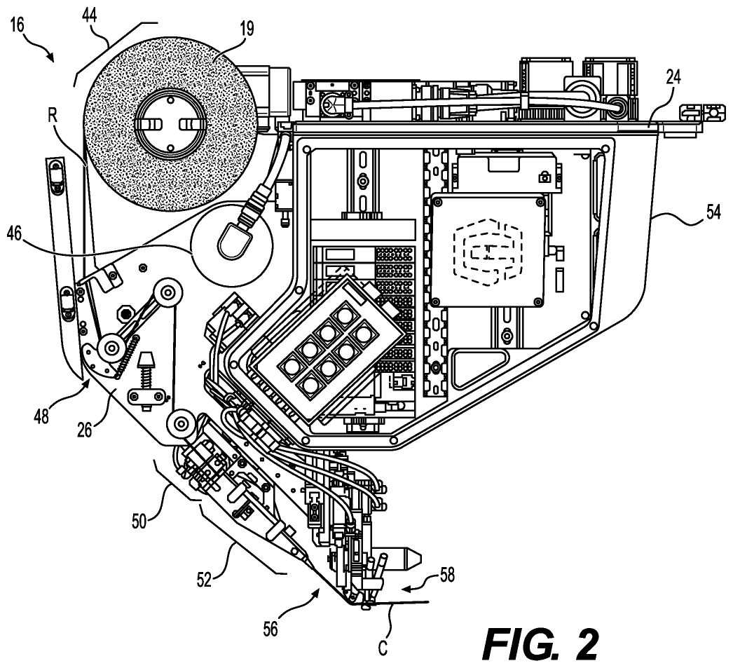

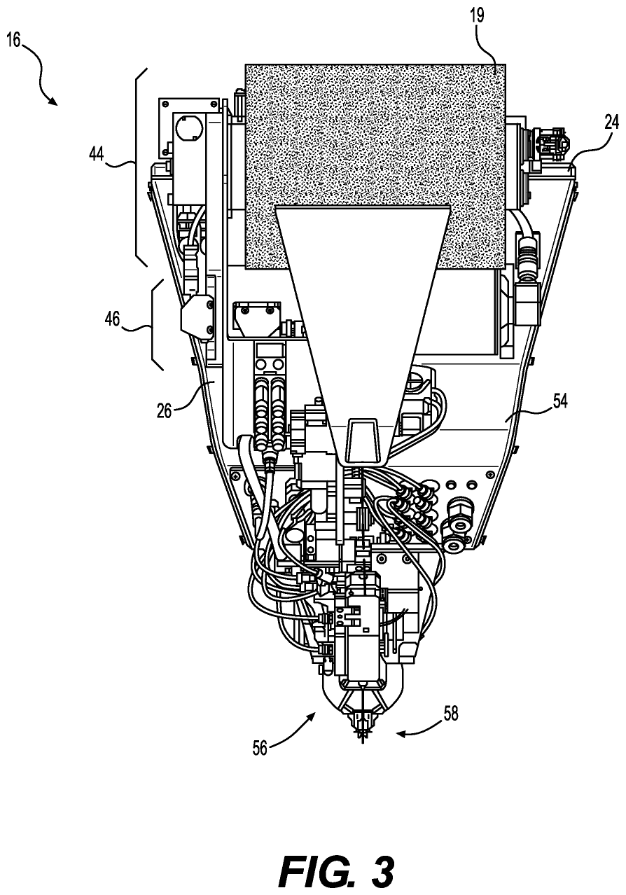

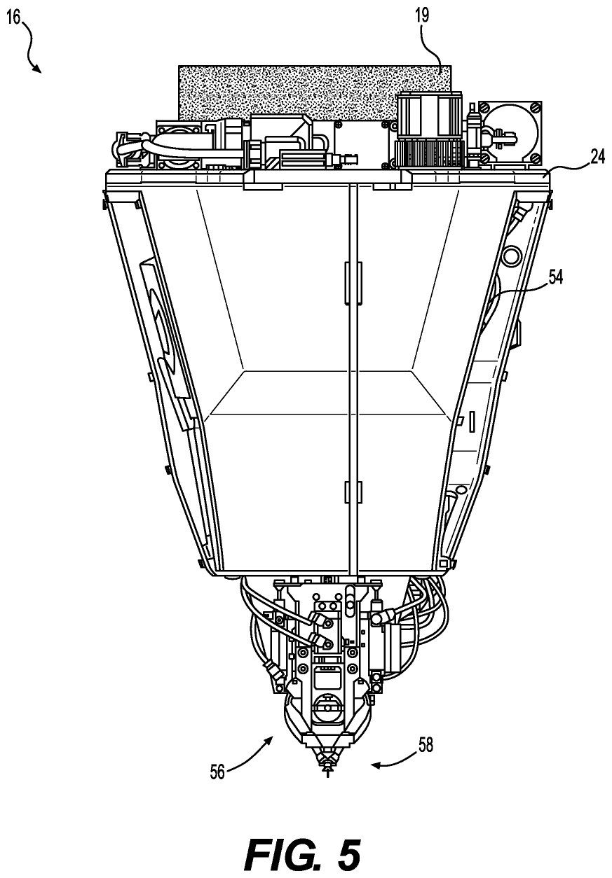

An exemplary head 16 is disclosed in greater detail in FIGS. 2, 3, 4 and 5. As can be seen in these figures, head 16 may include a mounting arrangement that is configured to hold, enclose, contain, and/or otherwise provide mounting for the remaining components of head 16. The mounting arrangement may include an upper generally horizontal plate 24 (e.g., upper plate as viewed from the perspective of FIGS. 2-5) and one or more generally vertical plates 26 (e.g., lower plates) that intersect orthogonally with upper plate 24. The other components of head 16 may be mounted to a front and/or back of lower plate(s) 26 and/or to a top or bottom side of upper plate 24. As will be explained in more detail below, some components may extend downward past a terminal end of lower plate(s) 26. Likewise, some components may extend transversely from lower plate(s) 26 past outer edges of upper plate 24.

Upper plate 24 may be generally rectangular (e.g., square), while lower plate 26 may be elongated and/or tapered to have a triangular shape. Lower plate 26 may have a wider proximal end rigidly connected to a general center of upper plate 24 and a narrower distal end that is cantilevered from the proximal end. Coupler 18 may be connected to upper plate 24 at a side opposite lower plate(s) 26 and used to quickly and releasably connect head 16 to support 14. One or more racking mechanisms (e.g., handles, hooks, eyes, etc. —not shown) may be located adjacent coupler 18 and used to rack head 16 (e.g., during tool changing) when head 16 is not connected to support 14.

As shown in FIGS. 2-5, any number of components of head 16 may be mounted to upper and/or lower plates 24, 26. For example, a reinforcement supply module 44 and a matrix supply module 46 may be operatively connected to upper plate 24, while a tensioning module 48, a clamping module 50, a wetting module 52, a cutting module 56, and a compacting/curing module 58 may be operatively mounted to lower plate(s) 26. It should be noted that other mounting arrangements may also be possible. As will be described in more detail below, the reinforcement may pay out from module 44, pass through and be tension-regulated by module 48, and thereafter be wetted with matrix in and discharged through module 52 (e.g., as supplied by module 46). After discharge, the matrix-wetted reinforcement may be selectively severed via module 56 (e.g., while being held stationary by module 50) and thereafter compacted and/or cured by module 58.

In some embodiments, the mounting arrangement may also include an enclosure 54 configured to protect particular components of head 16 from inadvertent exposure to matrix, solvents, and/or other environmental conditions that could reduce usage and/or a lifespan of these components. These components may include, among others, any number of conduits, valves, actuators, chillers, heaters, manifolds, wiring harnesses, sensors, drivers, controllers, input devices (e.g., buttons, switches, etc.), output devices (e.g., lights, speakers, etc.) and other similar components.

Module 44 may be a subassembly that includes components configured to selectively allow and/or drive rotation of creel 19 and the corresponding payout of reinforcement. As will be discussed in more detail below, the rotation of creel 19 may be regulated by controller 20 (referring to FIG. 1) based, at least in part, on a detected position of module 48. This rotational regulation may help to maintain one or more desired levels of tension within the reinforcement. For example, a nominal tension may be desired during normal material discharge; a higher or lower level of tension may be desired during free-space printing; and a higher level of tension may be desired during severing of the discharging material, and controller 20 may selectively implement these tensions based on detection of the corresponding operations.

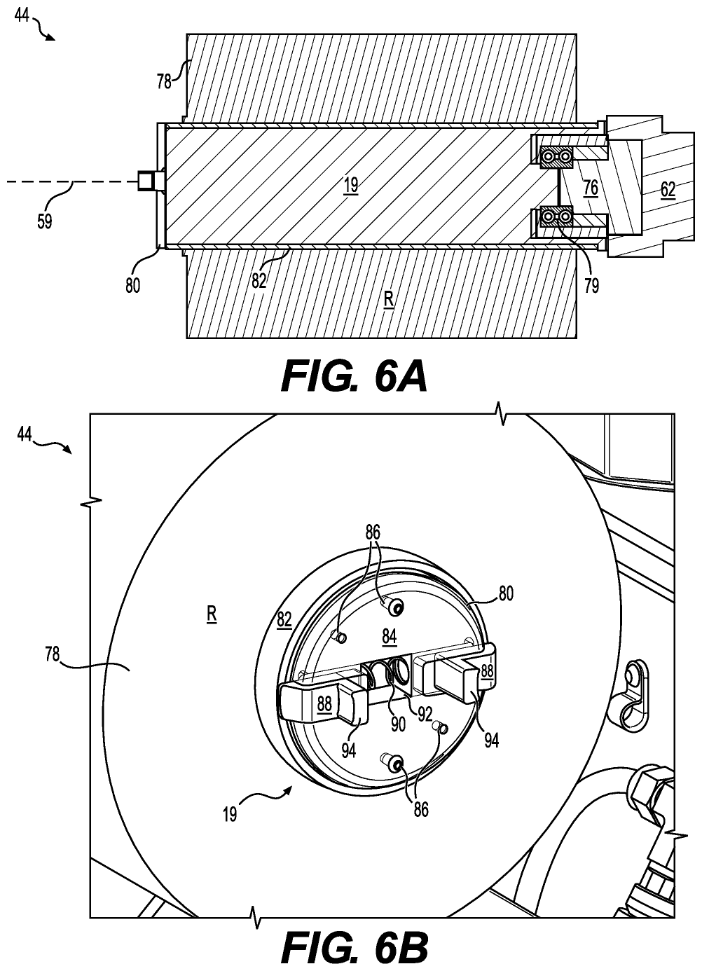

As shown in FIG. 6A, module 44 may be a subassembly that includes components configured to selectively allow and/or drive rotation of creel 19. These components may include, among other things, a rotating actuator 62 operatively connecting creel 19 to at least one of upper and lower plates 24, 26 (e.g., to only lower plate 26). During operation, controller 20 may selectively activate rotating actuator 62 to cause creel 19 to rotate and pay out reinforcement from a spool 78. In one example, rotating actuator 62 may include a rotor 76 rotationally affixed to creel 19. In this example, spool 78 may be easily removed (e.g., slipped axially off) from creel 19 and rotationally locked to rotor 76 (e.g., via a keyway, a friction device, etc.). Rotor 76 may be rotationally supported by lower plate 26 (or another parallel plate) via one or more bearings 79.

As shown in FIG. 6B, a quick-release mechanism 80 may be used to releasably connect spool 78 to creel 19 and to the rest of module 44. Spool 78 may include, among other things, a central core 82 configured to slide over and be received by creel 19, and one or more continuous reinforcements R wrapped around core 82. Mechanism 80 may include a flange 84 fixedly connected to an end of creel 19 opposite rotor 76 (e.g., via one or more fasteners and/or pins 86) and having an outer diameter less than an inner diameter of core 82. One or more tabs 88 may be moveably mounted to rotor 76, biased radially outward (e.g., via one or more springs 90), and manually and temporarily moved radially inward during installation. When tab(s) 88 are moved inward, core 82 may pass uninhibited by mechanism 80 over the end of creel 19. When tab(s) 88 are biased outward, tab(s) 88 may extend radially over at least a portion of (e.g., a rim) of core 82 to block spool 78 from inadvertently disengaging from creel 19.

Tab(s) 88 may slide within a channel 92 (e.g., in opposite directions) and include an inner end and an outer end. A fingerhold 94 may extend axially outward (i.e., relative to an axis of creel 19) from the inner end of each tab 88. Spring 90 may be disposed within channel 92, between the inner ends. The outer end of each tab 88 may be chamfered in the axial direction of creel 19, which may cause tab 88 to move radially inward against the bias of spring 90 in response to axial engagement with core 82 (e.g., only during loading).

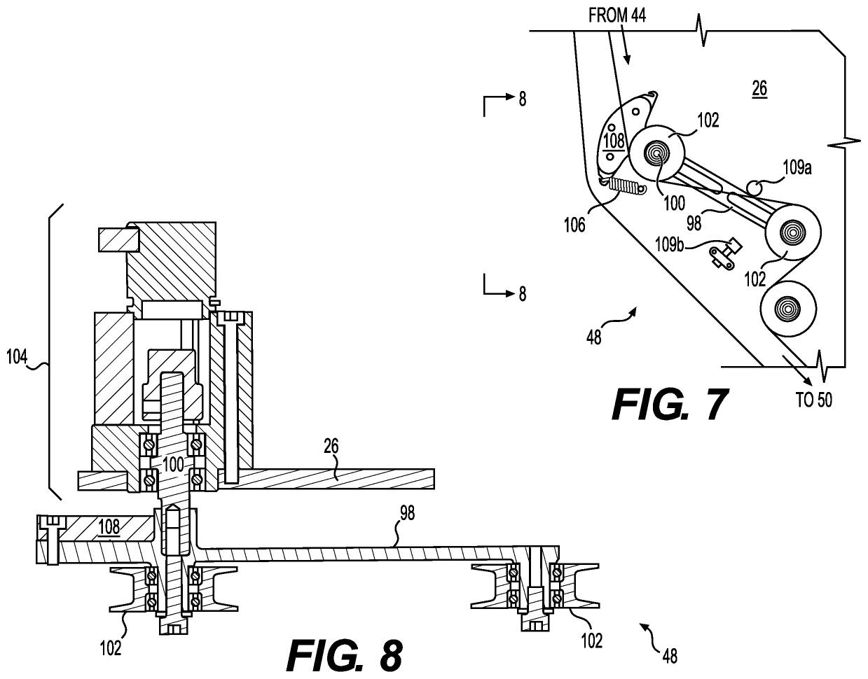

As shown in FIGS. 7 and 8, module 48 may be a subassembly located between modules 44 and 50 (e.g., relative to the travel of reinforcement through head 16) and include components configured to affect an amount and/or rate of the reinforcement being paid out by module 44 to module 50. These components may include, among other things, a swing arm 98 pivotally connected at one end (e.g., an end closest to module 44) to lower plate 26 via a pivot shaft 100, a redirect 102 rotatably mounted at each end of swing arm 98, and a rotary sensor (e.g., encoder, potentiometer, etc.) 104 (shown only in FIG. 8) connected to pivot with shaft 100 (e.g., at a side of plate 26 opposite swing arm 98).

In the disclosed embodiment, because the pivot point of swing arm 98 is located at an end thereof, swing arm 98 may not be balanced about shaft 100. If unaccounted for, this imbalance could cause swing arm 98 to function differently as head 16 is tilted to different angles during operation. Accordingly, in some applications, a counterweight 108 may be connected to or integrally formed with swing arm 98 at a side opposite the free end of swing arm 98.

In some embodiments, swing arm 98 may be biased (e.g., via one or more springs 106) toward an end or neutral position. Spring 106 may extend from one or more anchors on lower plate 26 to an end of counterweight 108 or arm 98 (e.g., a lower end located away from plate 24). In this embodiment, spring 106 is a tension spring. It is contemplated, however, that a single torsion spring mounted around pivot shaft 100 could alternatively be utilized to bias swing arm 98, if desired.

During operation, as the reinforcement is pulled out from head 16 at an increasing rate, swing arm 98 may be caused to rotate clockwise (e.g., relative to the perspective of FIG. 7) to provide a generally constant tension within the reinforcement. This rotation may result in a similar input rotation to sensor 104, which may responsively generate an output signal directed to controller 20 indicative of the increasing rate, tension, and/or tilt angle/position of swing arm 98. The signal may be directed to module 44 (e.g., directly or via controller 20), causing an increased payout (e.g., increased speed and/or amount of payout) of the reinforcement from creel 19. This increased payout may, in turn, allow swing arm 98 to return towards its nominal position. In one embodiment, a desired range of tension within the reinforcement may be about 0-5 lbs (e.g., about 0-1 lb). As the rate of reinforcement being pulled from head 16 decreases, spring 106 may rotate swing arm 98 in the counterclockwise direction to provide the generally constant tension within the reinforcement. During this counterclockwise motion, sensor 104 may again generate a signal indicative of the rotation, tension, arm tilt angle/position, etc. and direct this signal to controller 20 for further processing and control over module 44 (e.g., to cause a slowing payout of the reinforcement). It should be noted that controller 20 may process this signal and control module 44 via P, PI, PID, and/or other control methodologies, as desired.

One or more end-stops 109 may be associated with module 48 to limit a range of rotation of swing arm 98. In the disclosed embodiment, two different end-stops are provided, including a hard end-stop 109a and a high-tension end stop 109b. Swing arm 98 may naturally rest against hard end stop 109a due to the bias of spring 106. Swing arm 98 be selectively driven into high-tension end stop 109b during one or more operating events (e.g., a severing event).

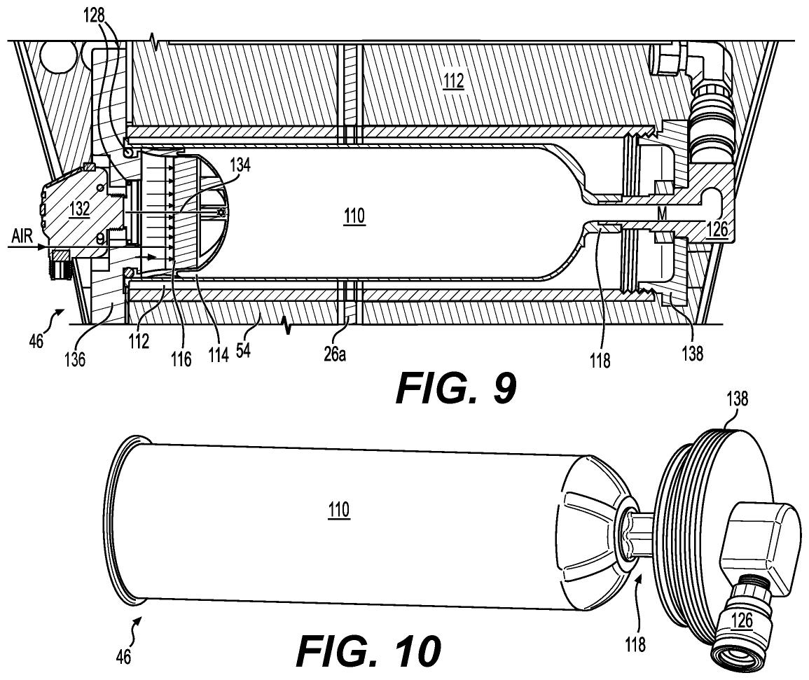

Module 46 may be configured to direct a desired amount of matrix at a specified rate, temperature, viscosity, and/or pressure to module 52 for wetting of the reinforcements received from module 44 via module 48. As shown in FIGS. 9 and 10, module 46 may be an assembly of components that receive, condition and/or meter out matrix from a disposable cartridge 110. Cartridge 110 may include, among other things, a tubular body 114, a cap 116 configured to close a base end of body 114, and a restricted outlet 118 located at an opposing tip end. The matrix inside body 114 may be selectively pressed through outlet 118 by axially translating cap 116 through body 114 towards outlet 118.

A pressure-regulated medium (e.g., air) may be directed against cap 116 at the base end of cartridge 110 to generate a force in the direction of outlet 118 that urges cap 116 to translate. The matrix discharging from outlet 118 may be directed through a port 126 toward module 52. In this way, a pressure and/or a flow rate of the medium into cartridge 110 may correspond with an amount and/or a flow rate of matrix out of cartridge 110. It is contemplated that a linear actuator, rather than the pressurized medium, may be used to push against cap 116, if desired. It is contemplated that controller 20 may implement P, PI, PID, and/or other control methodologies to regulate the flow of matrix from cartridge 110, as desired.

During discharge of the matrix from cartridge 110, care should be taken to avoid depletion of the matrix partway through fabrication of structure 12 (and/or at an unexpected time). For this reason, a sensor 132 may be associated with cartridge 110 and configured to generate a signal indicative of an amount of matrix consumed from and/or remaining within cartridge 110. In the depicted example, sensor 132 is an optical sensor (e.g., a laser sensor) configured to generate a beam 134 directed to cap 116 from the base end of cartridge 110. Beam 134 may reflect off cap 116 and be received back at sensor 132, wherein a comparison of outgoing and incoming portions of beam 134 produces a signal indicative of the consumed and/or remaining matrix amount. The signal may be used to generate an alert to a user of system 10, allowing the user to adjust operation (e.g., to pause or halt operation, park print head 16, swap out print heads 16, etc.), as desired. It is contemplated that another type of sensor (e.g., a magnetic sensor, an acoustic sensor, etc.) could be associated with cap 116 (and/or another part of cartridge 110) and configured to generate corresponding signals, if desired.

As shown in FIG. 9, one or more seals 128 may be located at the base end of cartridge 110, adjacent a mounting plate 136. Sensor 132 may be a standalone sensor having a nipple through which beam 134 is directed. A plate of transparent material (e.g., glass) may separate the nipple from cartridge 110, such that sensor 132 is protected from internal pressures and resin contamination. Beam 134 may pass through the transparent material substantially uninterrupted, such that an optical path is created to cap 116. Compliant material around the transparent material may function as seal 128, thereby prolonging a life of sensor 132.

It should be noted that the matrix contained within cartridge 110 may be light-sensitive. Accordingly, care should be taken to avoid exposure that could cause premature curing. In the disclosed embodiment, cartridge 110 may be opaque, transparent and tinted, coated (internally and/or externally), or otherwise shielded to inhibit light infiltration.

In some applications, handling and/or curing characteristics of the matrix may be affected by a temperature of the matrix inside of module 46. For this reason, module 46 may be selectively heated, cooled, and/or insulated accordingly to one or more predetermined requirements of a particular matrix packaged within cartridge 110. For example, one or more heating elements (e.g., electrodes—not shown) may be mounted inside of and/or outside of cartridge 110 and configured to generate heat conducted to the matrix therein. Controller 20 may be in communication with the heating element(s) and configured to selectively adjust an output of the heating element(s) based on a known and/or detected parameter of the matrix in module 46 and/or within other portions of head 16.

Cartridge 110 may be mounted in a way that allows simple and quick removal from head 16 and replacement upon depletion of the matrix contained therein. As shown in FIG. 10, a retainer 138 embodying a cap may threadingly engage a vessel 112 (referring to FIG. 9) configured to hold cartridge 110. In this embodiment, port 126 may be rotatably mounted in retainer 138 and threadingly engaged with outlet 118 of cartridge 110.

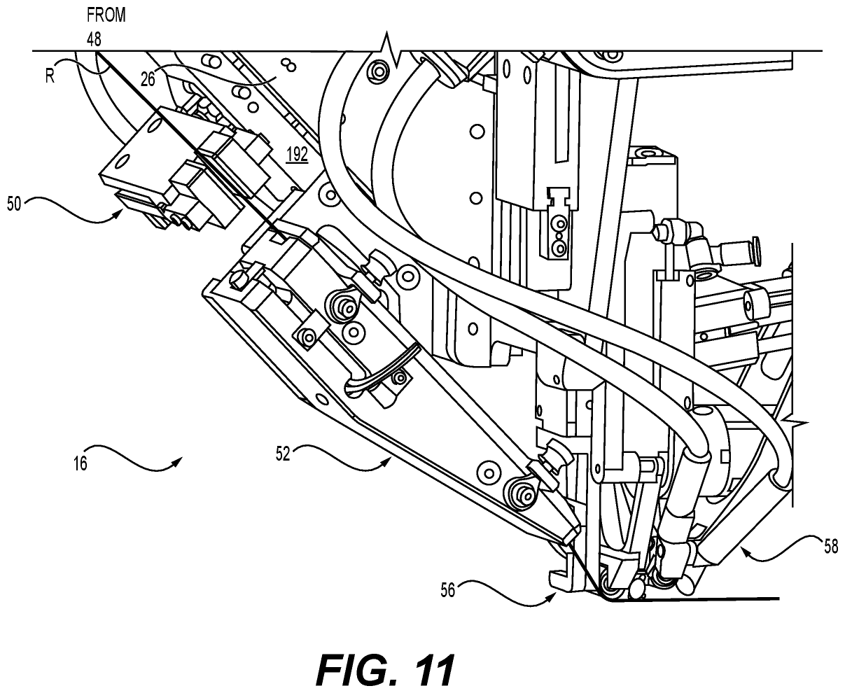

As shown in FIG. 11, clamping module 50 may primarily be configured to selectively clamp the reinforcement R and thereby inhibit movement (e.g., any movement or only reverse movement) of the reinforcement through head 16. This may be helpful, for example, during severing of the reinforcement away from structure 12, such that tensioning module 48 does not unintentionally pull the reinforcement back through head 16 after the reinforcement is separated from structure 12. This may also be helpful during off-structure movements of head 16 (e.g., when no reinforcement should be paying out) and/or briefly at a start of a new payout (e.g., while tacking the reinforcement at the anchor). In each of these scenarios, clamping module 50 may selectively function as a check-valve, ensuring unidirectional movement of the reinforcement through head 16. By allowing at least some movement of the reinforcement at all times, damage to the reinforcement may be reduced.

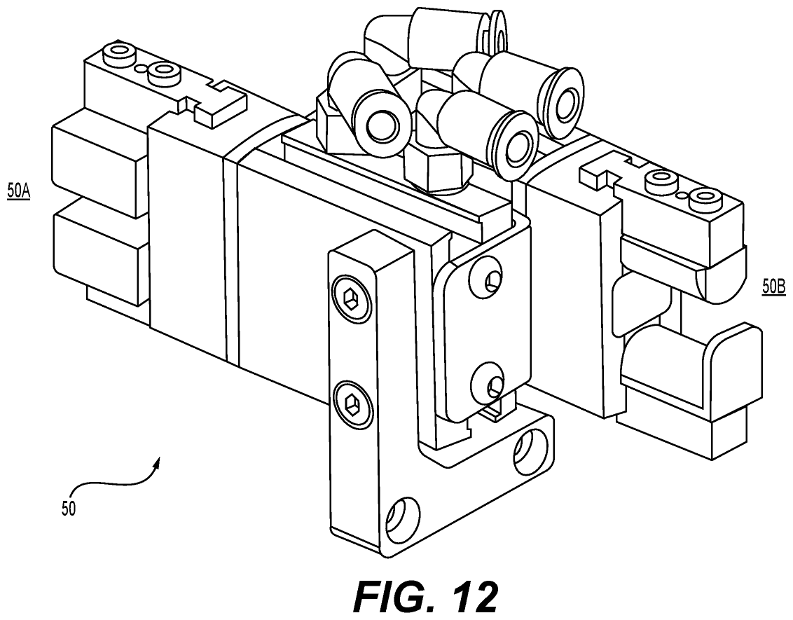

As shown in the example of FIG. 12, clamping module 50 may include components that cooperate to perform multiple different clamping functions at the same or different times. For example, module 50 may include a first clamping subassembly 50A having jaws extending in a first direction (e.g., a first direction that is transverse to a travel direction of fiber through head 16), and a second clamping subassembly 50B having jaws extending in a second direction opposite the first direction. The first clamping subassembly 50A may be selectively activated by controller 20 to clamp onto the reinforcement passing into module 52 (e.g., as shown in FIG. 11) and thereby inhibit relative motion between the reinforcement and module 52. The second clamping mechanism 50B may be selectively activated to clamp onto a supply line extending from module 46 to module 52 and thereby inhibit matrix flow into module 52. In one embodiment, second clamping mechanism 50B may include a lip that protrudes from an end of a lower jaw, upward past a side of the supply line to retain the supply line within the jaws of second clamping module 50B. Although connected together as a single module, first and second subassemblies 50A, 50B may be independently activated via separate actuators. In the disclosed embodiment, these actuators are pneumatically operated. It is contemplated, however, that these actuators may be hydraulically and/or electrically operated, if desired.

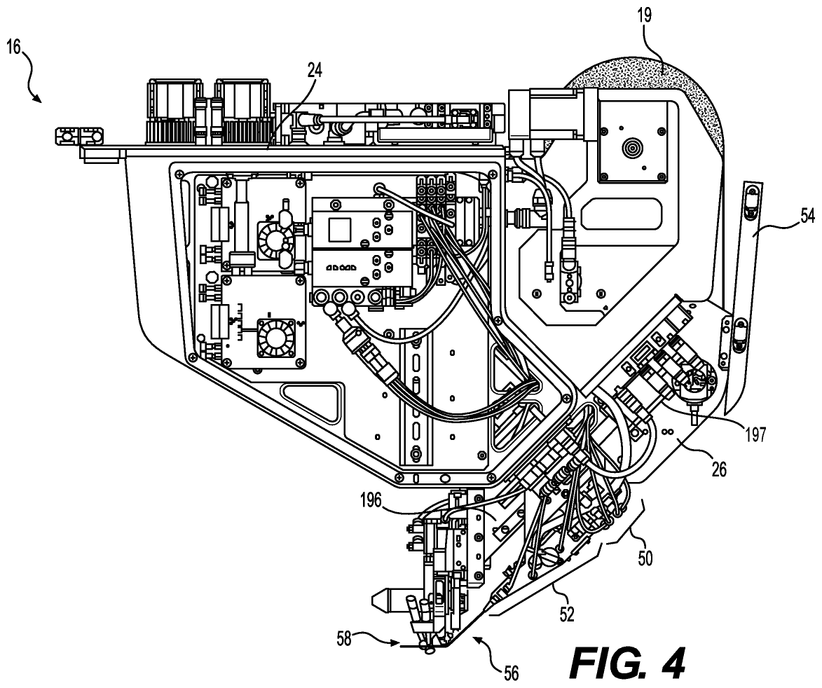

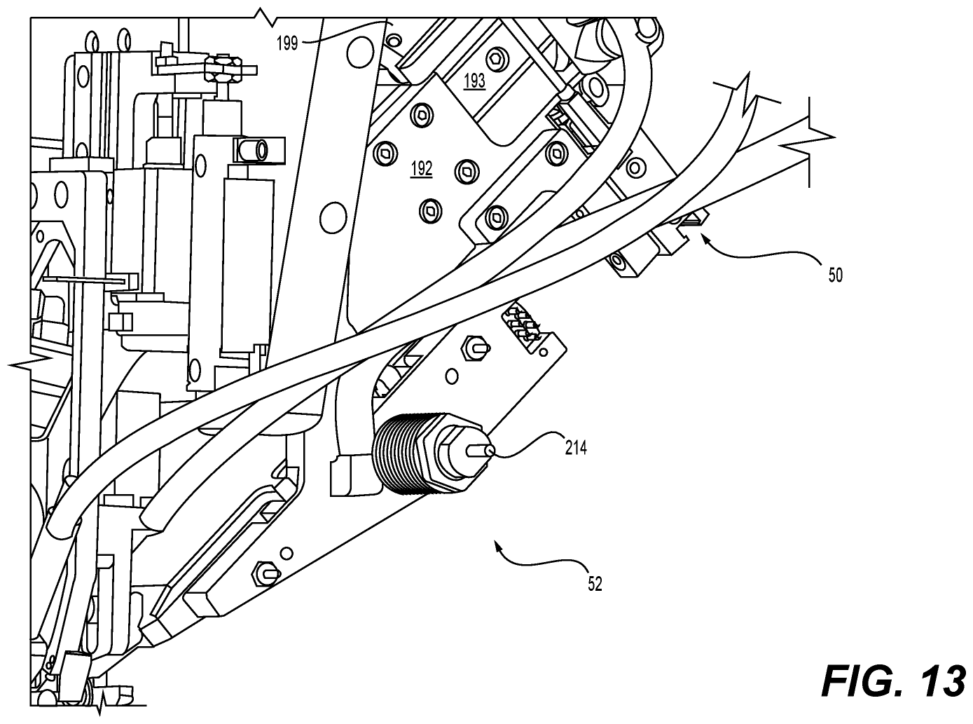

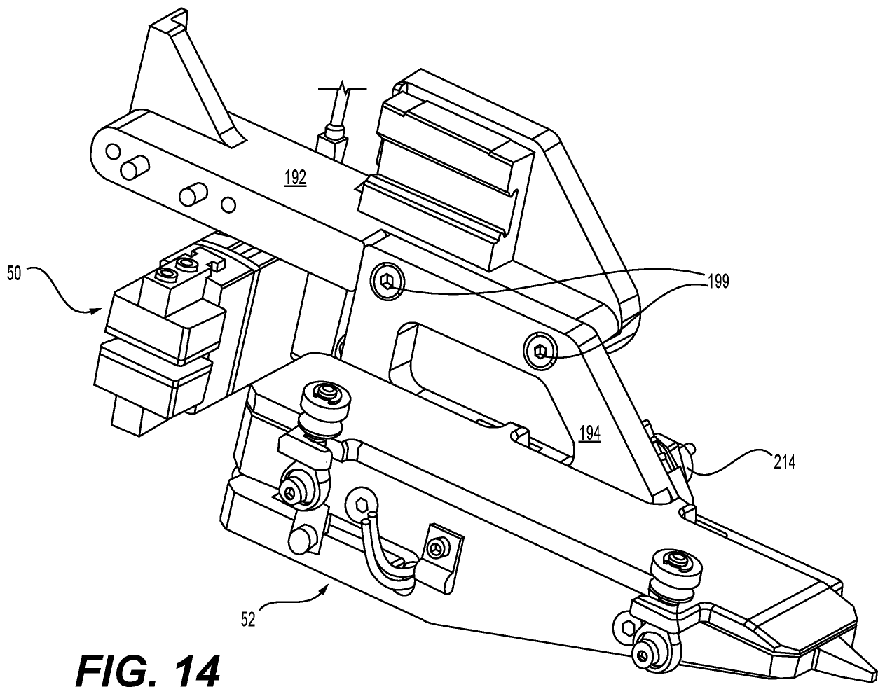

As shown in FIGS. 13 and 14, module 50 may be mounted to move together with module 52, relative to a rest of head 16. This movement may occur, for example, before, during, and/or after a severing event (e.g., after completion of a print path, during rethreading and/or during start of a new print path). Modules 50 and 52 may be rigidly connected to each other via a bracket 192 that translates (e.g., rolls and/or slides linearly) along a rail 193 (shown in FIG. 13) that is affixed to lower plate 26. Modules 50 and 52 may be located at a first side of lower plate 26, and rail 193 may be located at a second side of lower plate 26. An actuator 197 (shown only in FIG. 4) may be mounted to lower plate 26 at the second side and mechanically linked to an end of bracket 192. With this configuration, an extension or retraction of actuator 197 may result in translation of bracket 192, module 50 and module 52 along a length of rail 193.

It should be noted that, during the translation of bracket 192 and modules 50, 52 along rail 193, the reinforcement passing through modules 50, 52 may remain stationary or translate, depending on an actuation status of module 50 (e.g., of subassembly 50A). For example, when module 50 is active and clamping the reinforcement at a time of translation, the reinforcement may translate together with modules 50 and 52. Otherwise, a tension within the reinforcement may function to hold the reinforcement stationary, move the reinforcement in a direction opposite the translation, or move the reinforcement in the same direction of the translation at a different speed. A sensor 199 (shown in FIG. 13) may be associated with bracket 192 (e.g., disposed between lower plate 26 and bracket 192) to track the motion of modules 50, 52 and/or the payout of reinforcement. Sensor 199 may include, for example, a sensing component that is stationarily mounted to lower plate 26 and an indexing component (e.g., a magnet) mounted to bracket 192, or vice versa.

Module 52 may be connected to bracket 192 via an adapter 194 (shown in FIG. 14). Adapter 194 may connect to bracket 192 and to module 52 via one or more additional fasteners (not shown). In some embodiments, locating features (e.g., dowels, pins, recesses, slots, etc.) may be used to align adapter 194 with module 52 and/or bracket 192 before fastening, if desired.

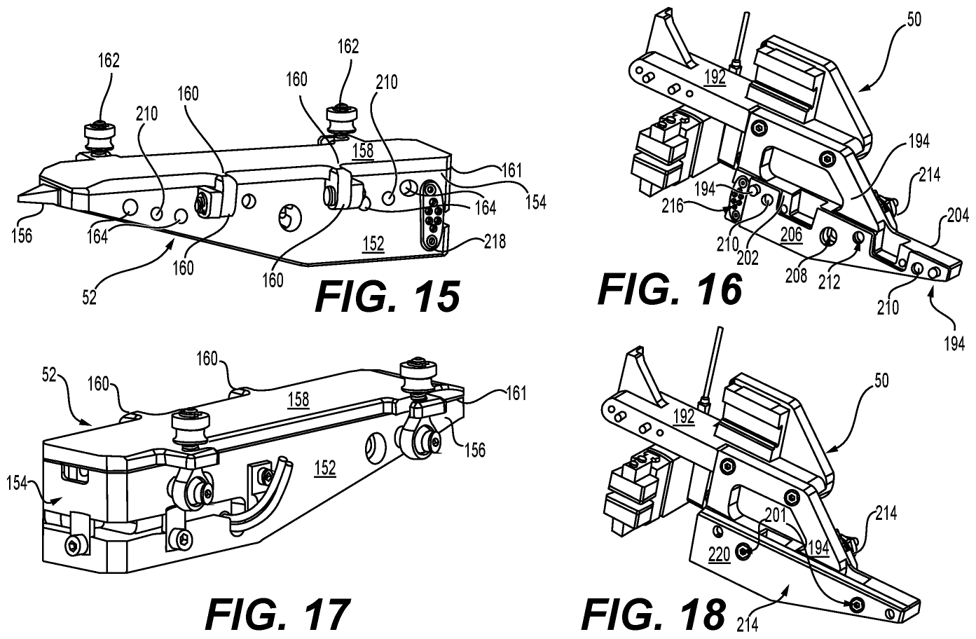

As shown in FIGS. 16 and 18, adapter 194 may be generally platelike, having an internal face 202 configured to mate against a side of module 52 (shown in FIG. 15), and an external face 204 located opposite module 52. Any number of ports may pass from face 204 through adapter 194 to face 202, and a seal 206 may be located at face 202 to seal around these ports.

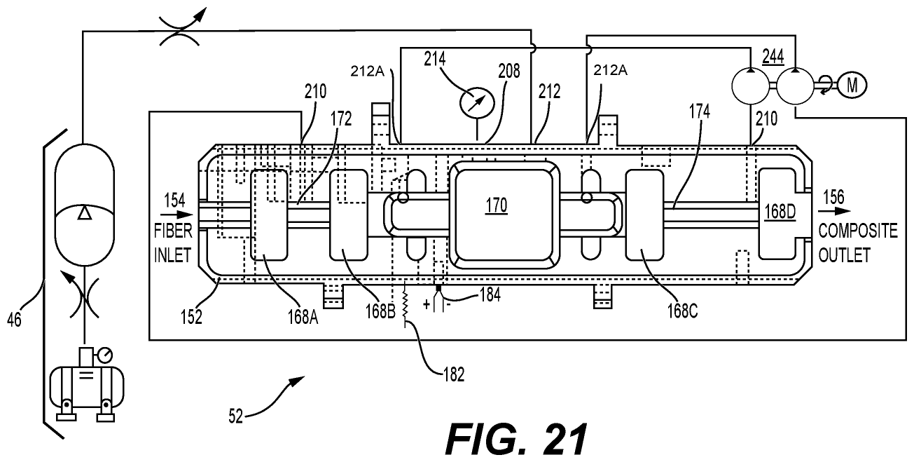

For example, at least one inlet port 212 may allow pressurized matrix from module 46 to pass through adapter 194 into module 52, and at least one outlet port 210 may allow excess or overflow matrix to drain or be pumped out of module 52 through adapter 194. In the disclosed embodiment, two outlet ports 210 are included and located at opposing sides of inlet port 212 (e.g., at lengthwise ends of module 52). In this embodiment, one or both of outlet ports 210 could selectively be utilized as an inlet port, if desired (e.g., matrix may be pulled from one port, depending on gravity, and pushed back into module 52 via the remaining port—see FIG. 21). An additional port 208 may function as a sensing port to allow any adapter-mounted sensor(s) (e.g., a temperature sensor, a pressure sensor, etc. —see FIGS. 16, 17 and 21) 214 to sense a characteristic of the matrix inside of module 52. A passthrough interface (e.g., a male interface) 216 may also be mounted to adapter 194 to allow for electrical connections with other component(s) (e.g., a heater, a sensor, etc.) mounted inside of module 52 (e.g., via a corresponding female interface 218 on module 52—shown in FIG. 15). When adapter 194 is not connected to module 52, a plate 220 (shown in FIG. 18) may close off face 202 to inhibit curing of matrix within ports 208, 210, 212. While adapter 194 is shown as separate from bracket 192 (e.g., for manufacturing purposes), it is contemplated that adapter 194 could be integral with bracket 192, if desired.

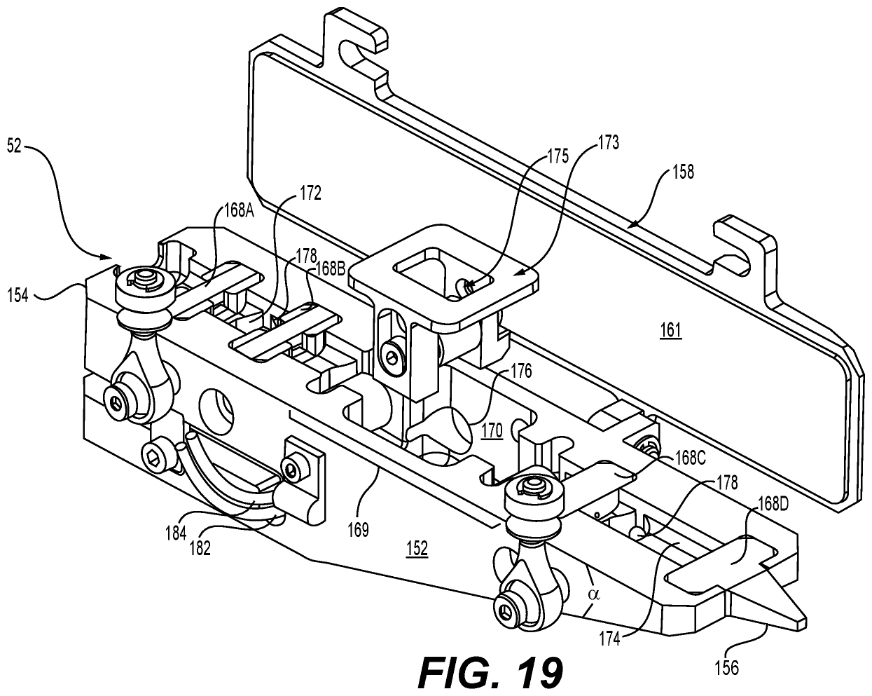

As shown in FIGS. 15 and 17, wetting module 52 may include an elongated (e.g., elongated in a direction of reinforcement motion through module 52) base 152 having a fiber inlet end 154 and a matrix outlet end 156. A lid 158 may be pivotally or otherwise removably connected to base 152 via one or more (e.g., two) hinges 160 located at a side adjacent adapter 194. A seal 161 may be disposed between base 152 and lid 158, and any number of fasteners (or quick release or toolless mechanisms) 162 may connect lid 158 to base 152 at one or more locations (e.g., spaced apart at a side opposite hinges 160). Lid 158 may be configured to pivot or otherwise be moved from a closed or operational position (shown in FIGS. 15 and 17) to an open or servicing (e.g., threading/cleaning) position (shown in FIG. 19).

Base 152 and/or lid 158 may include one or more features 164 for mounting module 52 to the rest of head 16. Features 164 may include, for example, bosses, holes, recesses, threaded bores and/or studs, dowels, etc. The number and locations of features 164 may be selected based on a weight, size, material, and/or balance of module 52.

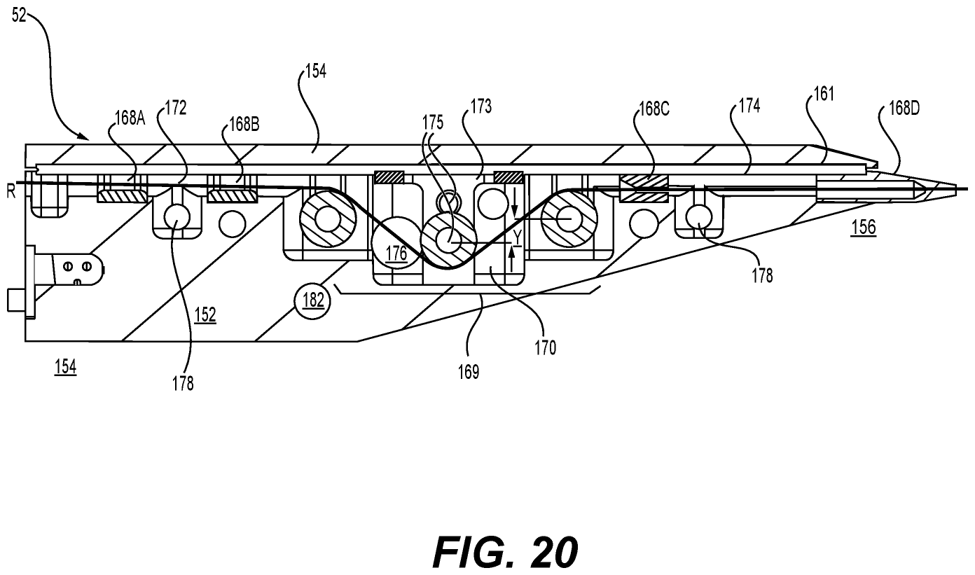

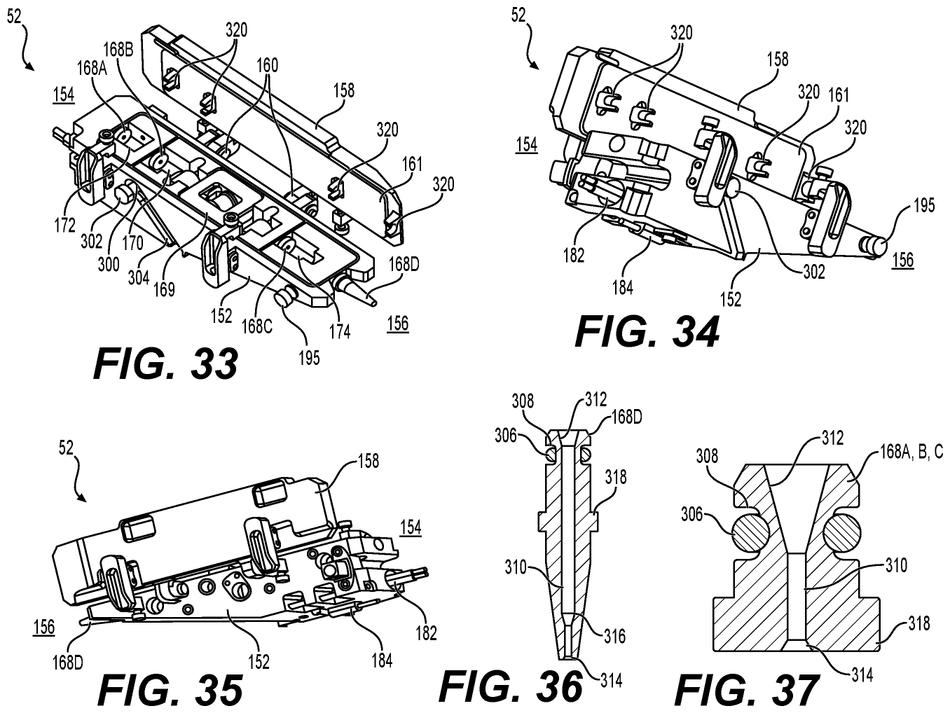

As shown in FIGS. 19 and 20, base 152 and lid 158 may together form an elongated enclosure that tapers towards outlet end 156. This tapering may reduce a formfactor of module 52, allowing a greater geometrical range of structure 12 (e.g., geometry having smaller internal angles) to be fabricated by system 10. In the example of FIG. 19, the taper may be formed via a single surface of base 152 tapering toward the plane of lid 158 at an angle α of about 10-20° (e.g., about) 15°. In another example, an additional taper located at an outlet end of lid 158 may increase the overall internal taper angle to about 30°. In some embodiments, a reinforcement anchor (shown in FIGS. 33 and 34) 195 may be connected to an outside of base 152 near outlet end 156 to capture a loose end of the reinforcement during storage (e.g., the loose end may be wrapped around anchor 165).

Base 152 may be configured to internally receive any number of nozzles 168 and/or teasing mechanisms 169 between inlet end 154 and outlet end 156. In the disclosed embodiment, four nozzles 168A, 168B, 168C and 168D are disposed in series along a trajectory of the reinforcement passing through module 52. It is contemplated, however, that a different number (e.g., a greater number or a lesser number) of nozzles 168 may be utilized, as desired. As will be explained in more detail below, nozzles 168 may function to limit an amount of matrix passing through module 52 with the reinforcement and/or to shape the reinforcement. In most instances, at least one entry nozzle 168A and at least one exit nozzle 168D should be employed to reduce undesired passage of matrix out of module 52 in upstream and downstream directions, respectively.

Nozzles 168 may divide the enclosure of module 52 into one or more chambers or sections. In the disclosed embodiment, nozzles 168 divide the enclosure into a main wetting chamber 170 located between nozzles 168B and 168C, an upstream overflow chamber 172 located between nozzles 168A and 168B, and a downstream overflow chamber 174 located between nozzles 168C and 168D. As will be explained in more detail below, chamber 170 may be a primary location at which the reinforcement is intended to be wetted with matrix. While the reinforcement may additionally be wetted within each of the overflow chambers 172 and 174, these overflow chambers 172 and 174 may primarily be intended as locations where excess resin can be collected and/or removed from module 52. The collection and removal of excess resin from overflow chambers 172 and 174 may help to inhibit undesired leakage from module 52 at ends 154 and 156.

Nozzles 168 may have different sizes and/or configurations. For example, nozzles 168A, 168B, and 168C may be slightly larger (e.g., have larger internal diameters) than nozzle 168D, in some applications. This may help to reduce friction acting on the reinforcement while the reinforcement is being pulled through main wetting chamber 170, yet still ensure precise control over a matrix-to-fiber ratio in the material discharging from module 52. In another example, the nozzle(s) 168 located upstream of mechanism 169 may have a shape that substantially matches an as-fabricated shape of the reinforcement (e.g., rectangular), while the nozzles 168 located downstream of mechanism 169 may have a different shape (e.g., circular or elliptical) designed to achieve a desired characteristic (enhanced steering and/or placement accuracy) within structure 12. It should be noted that circular or elliptical nozzles 168 may also be simpler and/or less expensive to manufacture with high tolerances.

Teasing mechanism(s) 169, if included within module 52, may be located inside main wetting chamber 170. Teasing mechanisms 169 may facilitate the intrusion (e.g., coating, saturation, wetting, etc.) of matrix throughout the reinforcement. In one example, this may be achieved by providing one or more pressure surfaces over which the reinforcements pass during transition through chamber 170. The pressure surfaces may press the matrix transversely through the reinforcements. In another example, the intrusion of matrix may be facilitated by the spreading out and/or flattening of individual fibers that make up the reinforcement (e.g., without generating a significant pressure differential through the reinforcement). In the disclosed example, multiple pressure surfaces cooperate to perform at least some (e.g., all) of these functions at the same time.

In the embodiment of FIGS. 19 and 20, mechanism 169 includes three rollers that are spaced apart from each other in the direction of reinforcement travel. With this configuration, the rollers may alternatingly press against opposing sides of the reinforcement. The rollers spaced furthest apart from each other may have axes that lie within a common horizontal (i.e., horizontal with respect to the perspective of FIG. 20) plane. The middle roller may have an axis that is parallel with the plane, but offset in a normal direction by a distance Y. The rollers may together cause the reinforcement R to deviate from a straight-line path through module 52, and the distance Y may correspond with an angle or amount of the deviation. A greater distance Y may result in a greater pressure differential generated by each roller and/or a greater amount of spreading/flattening/intrusion. However, a greater distance Y may also relate to a greater frictional or drag force acting on the reinforcement. In the disclosed embodiment, the distance Y may be about 0-15 mm (e.g., about 0-5 mm) and result in a corresponding interior angle of the reinforcement at the middle roller of about 60-150° (e.g., about 110° to 145°).

In the disclosed embodiment, variability may be built into the middle roller of mechanism 169. For example, a frame 173 having multiple axial positions 175 may be available for use with the middle roller, each position providing a different associated Y distance. In addition, the frame and middle roller may be replaced as a single unit with another frame and middle roller having a different range, number, and/or granularity of positions. The middle roller, being mounted within a frame that can be selectively removed from inside of chamber 170, facilitates threading of the reinforcement through module 52. One or more of the rollers (e.g., the middle roller) may also include flanges located at opposing axial ends. These flanges may help to retain a desired axial position of the reinforcement within module 52.

In some applications, the offset distance Y may be related to parameters of the reinforcement, the matrix intended to be effectively used inside module 52, and/or a sizing applied to the reinforcement by the reinforcement manufacturer. For example, brittle fibers may need more gentle redirecting achieved by either making the roller diameter larger and/or making the offset distance Y smaller. In another example, fibers with larger filaments (e.g., fiberglass has larger filaments than carbon fiber; T1100 carbon fiber has smaller filaments than AS4 carbon fiber; etc.) may be easier to impregnate and therefore require less pressure. In yet another example, smaller tows (e.g., 3 k, 300 Tex) maybe be easier to impregnate through the thickness than larger tows (e.g., 12 k, 1200 Tex) and therefor require less pressures. Lower viscosity resins are also easier to impregnate with. In general, the offset distance Y may grow as a cross-sectional area of the reinforcement and/or a viscosity of the matrix increases. The growing distance Y may result in a higher-pressure differential through the reinforcement that drives migration of the matrix.

As shown in FIG. 21, matrix may be pumped by module 46 into chamber 170 of module 52 via inlet port 212. In some embodiments, module 46 may be selectively activated to pump matrix into chamber 170 based on a detected pressure inside chamber 170. For example, when a pressure within chamber 170 drops below a low threshold pressure (e.g., about 0.25-0.35 psi or about 0.29 psi), controller 20 may generate a signal activating pumping of module 46. Likewise, when a high threshold pressure (e.g., about 0.85-0.9 psi or about 0.87 psi) is reached within chamber 170, controller 20 may stop sending the signal to module 46. Pressure sensor 214 may be in communication with the matrix inside chamber 170 via port 208 and be used to generate the above-described pressure signals.

Some of the matrix pumped into chamber 170, due to a pressure differential between chamber 170 and chambers 172 and 174, may leak both upstream into chamber 172 (e.g., through and/or around nozzle 168B) and downstream into chamber 174 (e.g., through and/or around nozzle 168C). In addition, depending on an orientation of head 16, gravity may force matrix from chamber 170 into chamber 172 or 174. This excess matrix, if unaccounted for, may continue to leak in the same manner upstream and/or downstream through or around nozzles 168A and/or 168D and be lost into the environment.

To avoid waste and environmental spillage of the matrix, the excess matrix may be drained from chambers 172 and 174 via outlet ports 210. A low-pressure source 224 may connect with ports 210 to remove the excess matrix collected within chambers 172 and 174. As indicated above, in some embodiments, the removed excess resin may be recirculated back into module 52 via the primary inlet port 212 or additional dedicated inlet ports 212A (shown in FIG. 21). In other embodiments, the removed excess resin may be discarded.

In some applications, a temperature of module 52 (e.g., of the matrix inside of module 52) may be regulated for enhanced wetting and/or curing control. In these applications, a heater (e.g., a ceramic heating cartridge—see FIG. 18) 182 and a temperature sensor (e.g., a Resistance Temperature Detector—RTD) 184 may utilized and placed at any desired location. In the disclosed example, heater 182 is located upstream of sensor 184, such that the matrix is heated before passing by sensor 184. The matrix may be heated to about 20-60° C. (e.g., 40-50° C.), depending on the application, the reinforcement being used, the matrix being used, and desired curing conditions. In general, a higher viscosity resin, a larger tow, and/or an opaquer reinforcement may require higher temperatures within module 52. However, care should be taken to avoid exceeding a cure-triggering threshold inside of module 52.

The materials of module 52 may be selected to provide desired performance characteristics. For example, base 152 and/or lid 158 may be fabricated from aluminum to provide a lightweight, easily machinable and low-cost component. In some embodiments, the aluminum may be coated with a non-stick and/or inert layer that protects against degradation by the matrix. This may include, for example a coating of Polytetrafluoroethylene (PTFE), parylene, or another polymer. Nozzles 168 may be fabricated from a high-hardness material for longevity in a highly abrasive environment. This material may include, for example, stainless steel (e.g., 303, 304 or 440c). In some applications, the stainless steel may need to be passivated to eliminate contact and reaction between iron within the stainless steel and the matrix. Alternatively, nozzles 168 may be fabricated from a ceramic material, if desired. Components of mechanism 169 may be fabricated from PTFE to provide low friction characteristics, and be kept as small as possible to reduce mass and inertia. Seal 161 and/or 206 may be fabricated from a closed-cell foam, such as a synthetic rubber and fluoropolymer elastomer commercially known as Viton, Tygon, silicon, or a PTFE foam.

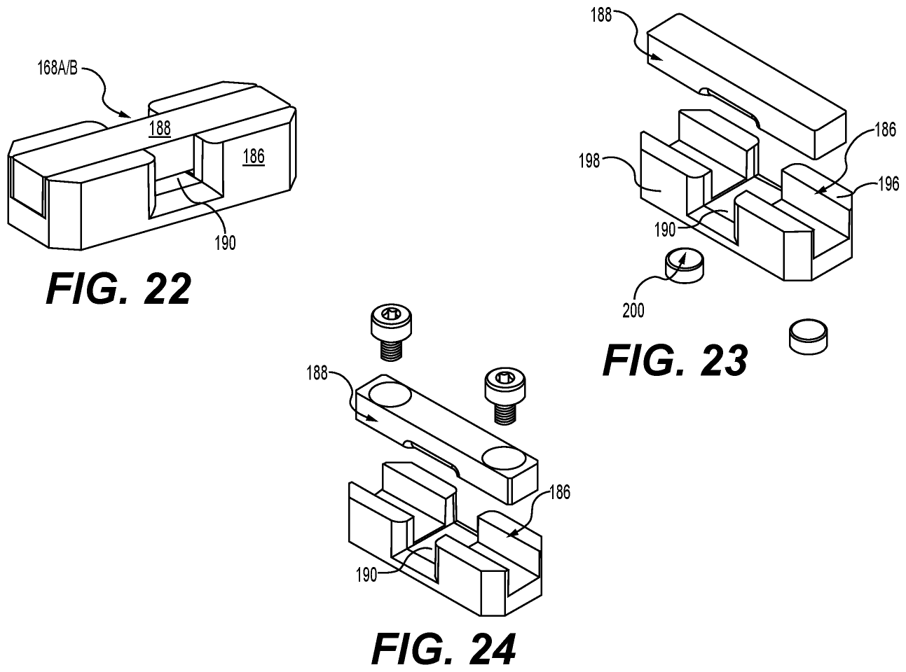

FIGS. 22, 23, and 24 illustrate an exemplary nozzle 168A and/or 168B. Although these nozzles are shown as being utilized twice within module 52, starting at inlet end 154, it is contemplated that these nozzle designs may be utilized a different number of times and/or in other locations, if desired. As shown in these figures, nozzle 168A/B may generally embody a 2-piece rectangular unit, including a base 186 and a lid 188 that together define a channel 190 through which the reinforcement passes. In the embodiment of FIG. 23, one or more magnets 200 may be embedded into one or both of base 186 and lid 188 to connect these components together in a removable manner. In the embodiment of FIG. 24, one or more fasteners may be located at transverse sides of channel 190 to connect lid 188 to base 186. In either embodiment, the rectangular unit may be removably fitted into corresponding rectangular slots formed in base 152 of module 52 (see FIG. 19), and oriented transversely to the travel direction of the reinforcement through module 52. In the depicted embodiments, each nozzle 168A/B may be completely recessed within base 152 (See FIG. 20). However, it is contemplated that nozzle 168 could alternatively be partially recessed within each of base 152 and lid 158, if desired (although this may increase a machining cost and complexity of module 52).

Base 186 of nozzle 168A/B may be configured to internally receive lid 188. For example, base 186 may form a three-sided enclosure, including an elongated spine, an entrance side 196 connected to a long edge of spine, and an exit side 198 connected to another long edge of spine opposite entrance side 196. Entrance and exit sides 196, 198 may extend a distance past an inner surface of spine to form a slot therebetween that is oriented orthogonally to an axis of the reinforcement passing through the nozzle 168A/B. Lid 188, when assembled to base 186, may fit completely into the slot, such that outer surfaces of lid 188 are generally flush with ends of entrance and exit sides 196, 198. The inner surface of spine may be recessed or stepped down away from lid 188 at a lengthwise center thereof to form three connected sides (e.g., a bottom side and connected transverse sides) of channel 190. An inner surface of lid 188 may be generally planar and form a fourth side (e.g., an upper side) of channel 190. With this configuration, a depth of channel 190 may be defined solely by the step formed within spine (e.g., a height dimension of the lateral sides), thereby allowing for easy machinability of channel 190 via conventional processes and high tolerances. In the disclosed example, the tolerances of channel 190 may be about +/−0.00025″, allowing for variance in a fiber-to-matrix ratio to be limited at about 2.5%. Outer edges of channel 190 may be rounded to reduce damage to the reinforcement passing therethrough.

In some embodiments, the rectangular shape of channel 190 may provide for optimum use of a similarly shaped reinforcement. That is, a reinforcement having an as-manufactured rectangular cross-section may pass through the rectangular shape of channel 190 without significant distortion. This may allow the reinforcement to pass over the pressure surfaces of mechanism 169 and be wetted in an efficient manner without causing damage to the reinforcements. In embodiments where all of the nozzles 168 have the rectangularly shaped channel 190, the reinforcements may be laid down against an underlying surface in a smooth or flat manner that reduces voids or undesired (e.g., uneven or bumpy) contours. However, it has been found that a rectangular discharge from channel 190 can be susceptible to rolling, folding, or overlapping itself inside and/or outside of nozzle 168D during discharge along a transversely curving trajectory. This may cause nozzle 168D to clog and/or result in undesired contours in the resulting surface of structure 12. Accordingly, in some embodiments, channel 190 within at least nozzle 168D may have a circular or ellipsoidal shape that facilitates smoother curving trajectories. In yet other embodiments, channel 190 may have only a curving shape (e.g., an incomplete arc of a circle) rather than a complete circle or ellipsoid, if desired.

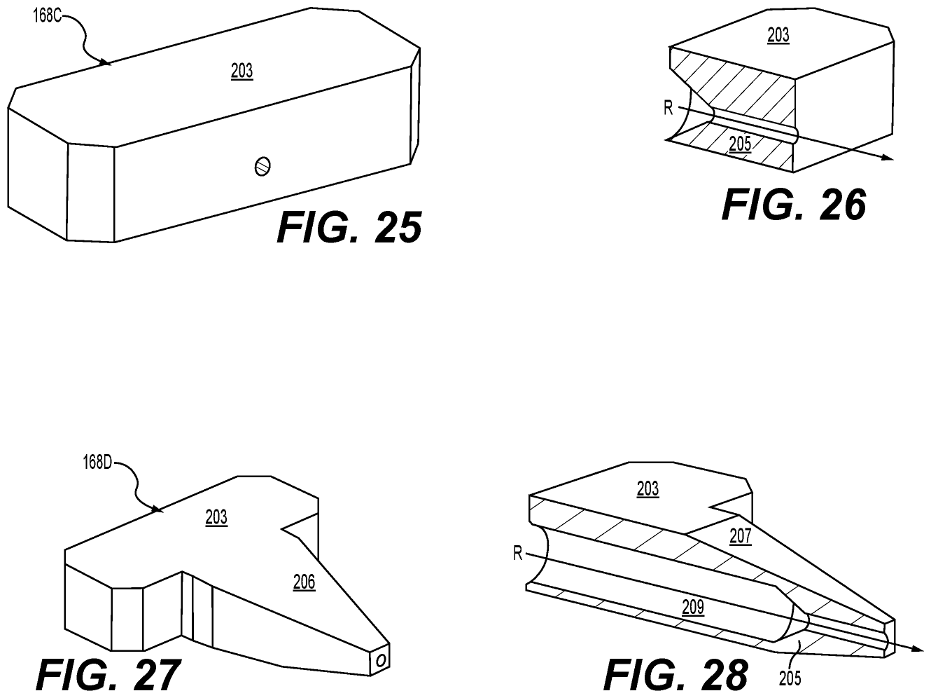

For example, FIGS. 25, 26, 27, and 28 illustrate exemplary nozzles 168C and 168D each as having a generally circular cross-sectional bore. The location of these nozzles downstream of mechanism 169 may allow for enhanced wetting while the reinforcement remains in it's as-manufactured shape and enhanced steering during discharging via molding of the reinforcement into a curving shape. In these embodiments, nozzles 168C/D may each be unibody components having a similar rectangular base 203 that fits inside of wetting module base 152 and a similar internal bore (e.g., tapered and circular orifice). Nozzle 168D, however, may have an elongated and tapering tip end 207, in which an internal shape 205 is formed. The tapering of tip end 207 may help to enhance the formfactor of module 52. In the embodiment of FIG. 28, a larger internal bore 209 may pass through base 203 and communicate with the internal shape 205, without increasing backpressure or friction. It is contemplated that nozzles 168C and 168D could be identical, if desired.

In one embodiment, at least nozzle 168D has a cross-sectional area selected to limit an amount of matrix clinging to the reinforcement being discharged from module 52. In this example, the cross-sectional area of nozzle 168D may be 0-150% greater (e.g., 65-150% greater) than the cross-sectional area of the reinforcement alone. It is contemplated that upstream nozzles 168A-C may have the same cross-sectional area as nozzle 168D to simplify and lower a cost of module 52. However, it is also contemplated that the upstream nozzles 168A-C could have different (e.g., larger) cross-sectional areas, if desired (e.g., to facilitate threading and/or reduce drag). For example, for a desired fiber-to-matrix ratio of 50% or lower, all nozzles 168 may have identical cross-sectional areas, as drag at these ratios may be insignificant. However, at ratios greater than 50%, one or more upstream nozzles 168 (e.g., nozzles 168A, B, and/or C) may have identical larger internal geometry that reduces drag, while one or more downstream nozzles (e.g., nozzles 168C and/or D) may have tighter internal geometry that provides for the desired ratio. In another example, the upstream nozzles 168 could have tighter geometry to inhibit undesired leakage of resin at the upstream locations.

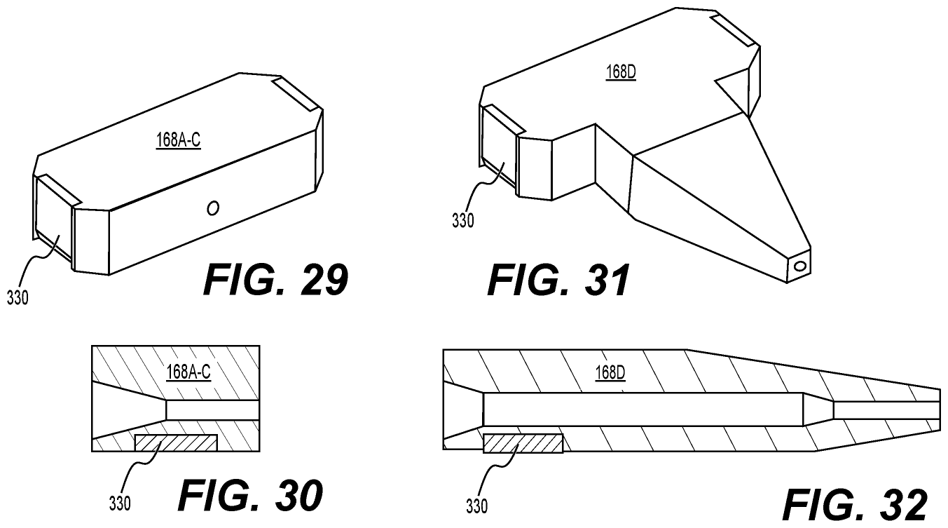

FIGS. 29, 30, 31 and 32 illustrate alternative exemplary nozzles 168A-D that are similar to the embodiments of FIGS. 25-28. Like the nozzles of FIGS. 25-28, nozzles 168A-D of FIGS. 29-32 may externally be generally cuboid and have cylindrical internal passages. However, in contrast to the nozzles of FIGS. 25-28, nozzles 168A-D of FIGS. 29-32 may additionally include a seal 330 that wraps at least partially around base 203. In the disclosed embodiment, seal 330 wraps around three sides of base 203 (e.g., around a bottom side, and opposing lateral sides). In this embodiment, an upper side of base 203 located opposite the bottom side and extending between the opposing lateral sides may be sealed via seal 161 associated with lid 158 (referring to FIG. 19). Seal 330 may be applied to base 203 via overmolding, adhesive-backing, or another technique and inhibit matrix leaking through around the sides of each nozzle 168.

An alternative wetting module 52 is illustrated in FIGS. 33, 34 and 35. As can be seen in these images, this module 52 may include base 152, lid 158, seal 161, nozzles 168, teasing mechanism 169, heater 182 and sensor 184. However, the arrangement and/or configurations of these elements may be different than in the previously disclosed embodiments. For example, while heater 182 and sensor 184 may still be in communication with main chamber 170 (e.g., with heater 182 being located further upstream than sensor 184), heater 182 may approach chamber 170 through a bottom side of base 152 (e.g., from a side opposite lid 158) and sensor 184 may be mounted to an external surface of base 152 at the bottom side. This rearrangement may provide increased heating efficiency, particularly in situations where a lesser amount of matrix is present within chamber 170. In addition, at this orientation, there may be a lower risk of associated wiring becoming bent and/or broken.

The module 52 embodiment of FIGS. 33-35 also has new geometry that facilitates a startup and/or purge process. For example, a bleed port 300 (shown in FIG. 33) may be formed in communication with main chamber 170. Bleed port 300 may be normally closed off, for example via a plug 302. During startup of system 10, wetting module 52 may be bled of air trapped therein by removing plug 302 or otherwise opening bleed port 300 and pumping pressurized matrix into main chamber 170. This may continue for a set period of time, until air no longer is pushed through bleed port 300, and/or until matrix discharges through bleed port 300. A drain channel 304 may be formed within an outer side surface of base 152 and configured to direct any matrix purged through bleed port 300 to a drip location away from discharge end 156. In the disclosed embodiment, drain channel 304 starts at bleed port 300 near an open top side of base 152, and extends forward (e.g., closer towards discharge end 156) and toward the back side of base 152. A disposable reservoir (not shown) may be placed at an exit end of channel 304 during the startup/purging operation to collect any purging matrix.

As can be seen from FIGS. 36 and 37, nozzles 168 have also been modified for the wetting module embodiment of FIGS. 33 and 34. For example, nozzles 168 in this embodiment may have a rounded exterior shape (i.e., cylindrical rather than cuboid). This may allow for a random placement and orientation within base 152 of module 52 (e.g., during first assembly and subsequent maintenance activities) that provides for an extended useful life of these components. In addition, each of nozzles 168 may include a seal (e.g., an o-ring) 306 retained within an annular groove 308 located at an upstream end and configured for an interference fit within a corresponding bore (not shown) in base 152.

As can be seen in FIGS. 36 and 37, each of nozzles 168 may include a central passage 310 that tapers outward at both entrant and exit ends 312, 314. In the disclosed embodiment, an angle of tapers at ends 312, 314 may be about 30-60° relative to an axis of the central passage. Nozzle 168 may have an additional taper 316 located closer to the exit taper than the entrant taper. An angle of taper 316 may be less than about 45° (e.g., about 30°). The entrant taper may facilitate threading of the reinforcement through nozzle 168. In some embodiments, an entrant diameter-to-exit diameter ratio may be limited to a maximum of 3.5 or threading can become too difficult (e.g., by causing buckling). Similarly, a passage depth-to-diameter (not including entrant/exit taper diameters) ratio may be about 7 to 15, as anything outside this range may make fabriction too difficult and/or expensive. The exit taper may inhibit fraying of the reinforcement. Taper 316 may allow for a reduced cross-sectional area that sets a predefined ratio of reinforcement to matrix. Interchangeable nozzles 168D may be available with differently sized cross-sectional areas downstream of taper 316 to provide different ratios.

Each of nozzles 168 shown in FIGS. 36 and 37 may include a placement shoulder 318 configured to facilitate accurate placement of the corresponding nozzle 168 into base 152 (referring to nozzles 168A,B,C) and/or accurate placement of nozzle 168D relative to module 58. While shoulders 318 may inhibit insertion past a desired position, care should still be taken to ensure that nozzles 168 are inserted far enough (e.g., up to engagement with base 152) and remain fully seated during operation. For this purpose, one or more positioning/retaining devices 320 may be included within module 52. In the disclosed embodiment, one such device 320 is provided separately for each nozzle 168 and protrudes from an inner surface of lid 158 (e.g., through an opening in seal 161). As can be seen in FIG. 34, each device 320 may be generally forked, having an open center to allow passage of the reinforcement extending through the corresponding nozzle 168. The tines (curved or straight tines) located at each side of the open center may be configured to engage an end surface of shoulder 318 opposite base 152 to ensure an adequate insertion depth. In the disclosed embodiment, the tines taper, such that the corresponding nozzle 168 is urged further into the bore of base 152 as lid 158 is pivoted to a greater degree of closure. In one embodiment, the taper may be about 90-135°. A taper outside this range may not allow for smooth closure of lid 158.

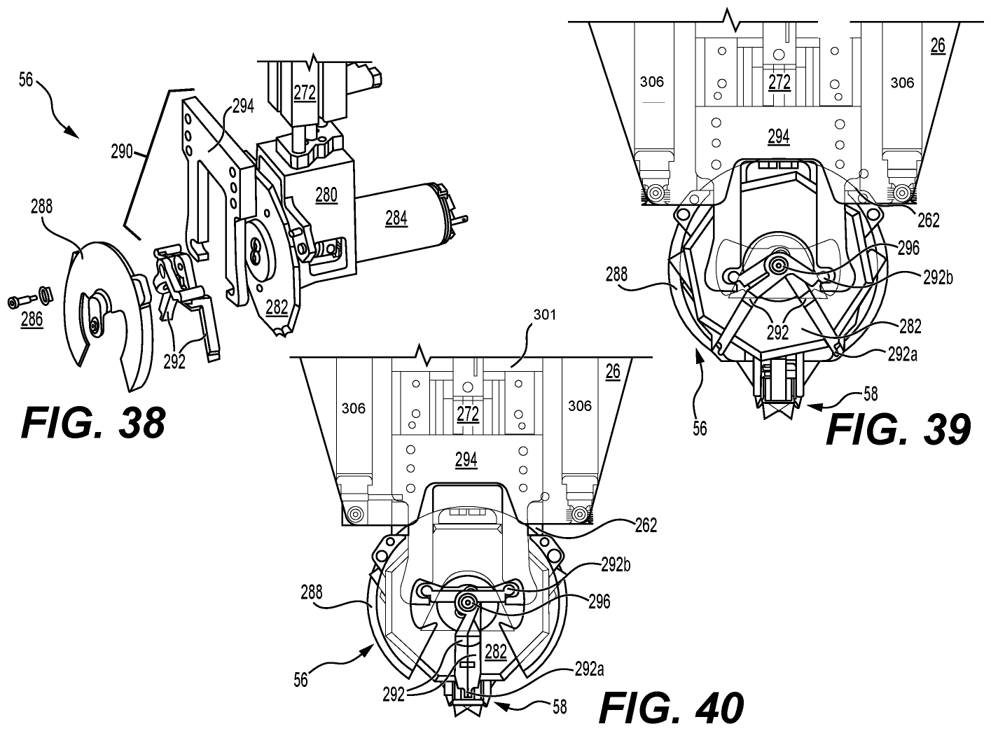

An exemplary module 56 is shown in FIGS. 38, 39 and 40. As can be seen from these figures, module 56 may be an assembly of components that cooperate to sever the reinforcement passing from module 52 to module 58. These components may include, among other things, a mounting bracket 280 connected to actuator 272, a cutting mechanism (e.g., a rotary blade) 282, a cutting actuator (e.g., a rotary motor) 284 connecting mechanism 282 to bracket 280 via associated hardware (e.g., bearings, washers, fasteners, shims, gears, belts, etc.) 286, and a cover 288 configured to at least partially enclose (e.g., enclose on at least two or at least three sides) cutting mechanism 282. With this configuration, an extension of actuator 272 may cause cutting mechanism 282 to protrude into a trajectory of the reinforcement approaching module 58. Activation of actuator 284 may cause mechanism 282 to rotate such that, during the protruding, mechanism 282 may sever the reinforcement. Cover 288 may protect against unintentional contact with a cutting edge of mechanism 282 and also function to collect dust and debris cast radially outward from mechanism 282 during severing. It is contemplated that actuator 284 may be configured to affect a different severing motion (e.g., a vibration, a side-to-side translation, etc.) of mechanism 282, if desired.

In some applications, engagement of the rotating cutting mechanism with the reinforcement can cause the reinforcement to deviate from a desired location relative to module 52 and/or 58 (e.g., transversely out of axial alignment with nozzles 168). If unaccounted for, this deviation could result in improper placement of the reinforcement within structure 12.

To help avoid undesired deviation and improper placement of the reinforcement caused by engagement with cutting mechanism 288, transverse motion of the reinforcement may be selectively inhibited during severing. This may be accomplished, for example, via a guide 290.

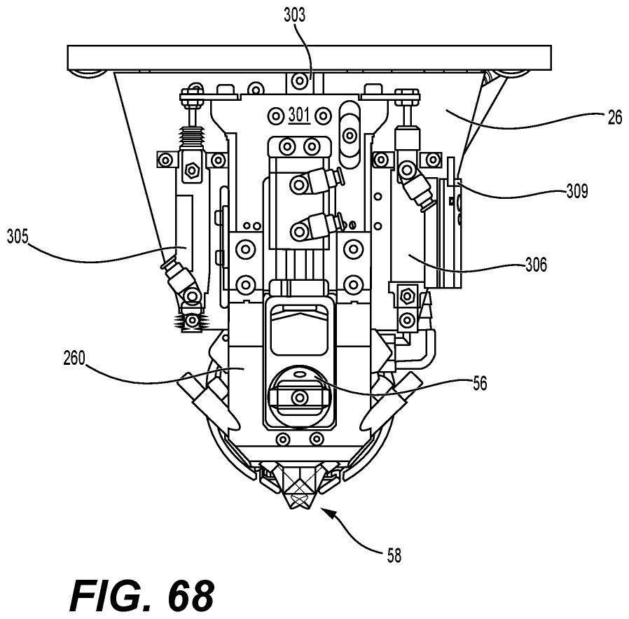

Guide 290 may be an assembly of components that cooperate to selectively inhibit undesired motion (e.g., transverse motion relative to a trajectory past cutting mechanism 282) of the reinforcement during severing. These components may include, among other things, one or more (e.g., a pair of) arms 292 and an extension 294 that extends from a carriage 301 (discussed below in regard to FIG. 68) to arm(s) 292.

As shown in FIGS. 39 and 40, each of arm(s) 292 may include a distal end 292a configured to abut the reinforcement at one side (e.g., relative to the trajectory of the reinforcement), and a proximal end 292b configured to operatively engage a corresponding feature (e.g., a pocket or recess) of extension 294. Each of arm(s) 292 may be pivotally connected to actuator 284, for example via a bearing 296. This connection may allow free pivoting of arm(s) 292 about bearing 296 and simultaneous translation together with actuator 284 and mechanism 282 that is unaffected by rotations thereof.

In the disclosed embodiment, each of arm(s) 292 is generally L-shaped, having a first and longer segment extending from bearing 296 to distal end 292a, and a second and shorter segment extending from bearing 296 to proximal end 292b at an angle of about 60-120° (e.g., about 90°) relative to the first segment. A portion of proximal end 292b (e.g., a pin, a stud, a boss, etc.) may protrude in a direction toward mechanism 282 to pivotally engage the corresponding pocket of extension 294. In this configuration, translation of actuator 284 and mechanism 282 relative to extension 294 (e.g., via extension of actuator 272) may cause pivoting of arm(s) 292 between an open position (shown in FIG. 39) and a closed position (shown in FIG. 40) via the linkage of proximal end(s) 292b with the pockets of extension 294. When arms 292 are in the closed position, a spacing therebetween and a corresponding distance that the reinforcement is allowed to deviate from a nominal position may be smallest. In one example, the spacing may be related to a cross-sectional area of the reinforcement (e.g., the ration of area-gap may be about 0.5 or greater for proper severing of the reinforcement).

It should be noted that a single arm 292 placed to oppose motion of the reinforcement caused by engagement with the rotating edge of mechanism 282 may be sufficient in some applications. However, paired arms 292 may allow for mechanism 282 to be rotated in any direction and still provide sufficient resistance to reinforcement motion. In fact, in some applications, actuator 284 may be controlled to switch rotation directions for every other severing event, thereby extending a lifespan of mechanism 282 (e.g., by using twice as much cutting edge at each vertex of mechanism 282).

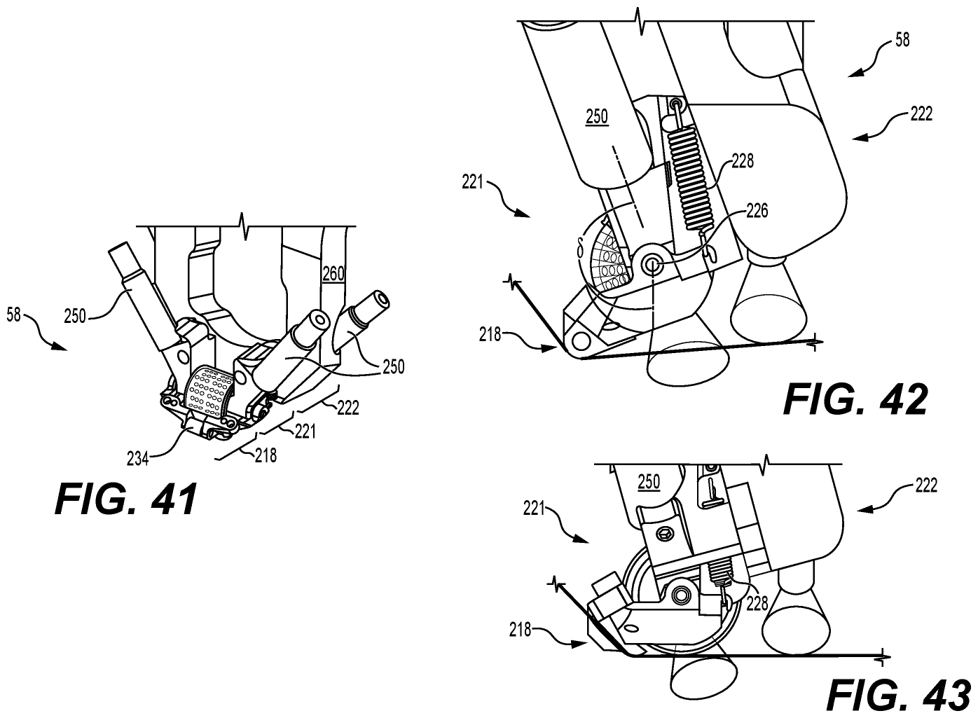

An exemplary module 58 is illustrated in FIGS. 41, 42 and 43. As shown in these figures, module 58 may be broken down into multiple (e.g., two, three, or more) subassemblies. These subassemblies may include one or more of a leading (i.e., leading relative to a traveling direction of head 16 during normal material discharge and fabrication of structure 12) subassembly 218, a trailing subassembly 221, and a curing subassembly 222. As will be explained in more detail below, each of these subassemblies may be connected to each other to form module 58 and move together to wipe over (e.g., smooth, distribute matrix, etc.), compact, and/or cure the material discharging from module 52. For example, subassembly 221 may be rigidly mounted to a leading side of subassembly 222 via one or more fasteners (not shown), and subassembly 218 may be pivotally mounted to a leading side of subassembly 221 (e.g., opposite subassembly 222) via one or more (e.g., two) pins 226. A spring 228 may extend between subassemblies 218 and 221 to bias subassembly 218 against the discharging material (e.g., downward away from head 16—see FIG. 42). As module 58 is moved towards the material, subassembly 218 may be the first to engage the material. Further movement may cause subassembly 218 to pivot upwards against the bias of spring 228 and away from the material, until subassembly 221 also engages the material (see FIG. 43).

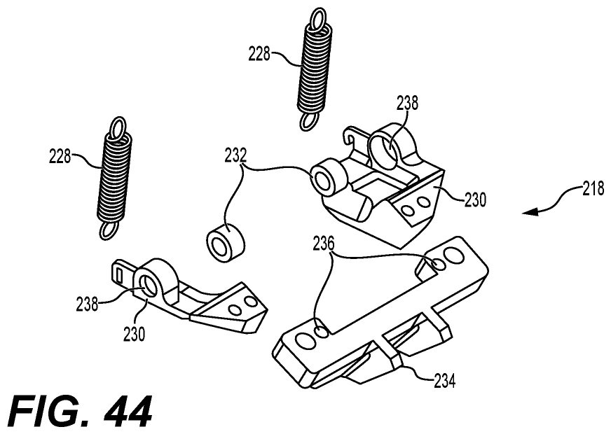

Subassembly 218 may be the first subassembly of module 58 to engage and condition the material discharging from module 52, relative to the normal travel direction of head 16. As shown in FIG. 44, subassembly 218 may include, among other things, pivoting end brackets 230 that mount to pins 226 of subassembly 221 (see FIG. 42) via respective bearings 232, a conditioner 234, and one or more (e.g., two) springs 228. Conditioner 234 may extend laterally across leading ends of brackets 230 and be held in place by one or more fasteners 236. Springs 228 may engage trailing ends of brackets 230 to bias the pivoting of conditioner 234 toward the discharging material. Bearings 232 may mount inside corresponding bores 238 located midway between the leading and trailing ends of brackets 230. In one example shown in FIGS. 43 and 44, conditioner 234 is a blade-like wiper fabricated from a compressible and/or low-friction material (e.g., PTFE). In another example shown in FIGS. 41 and 42, conditioner 234 is a cylindrical rolling or non-rolling wiper. It is contemplated that both a roller and a wiper could be utilized together within subassembly 218 (e.g., in series), if desired. Conditioner 234, in addition to providing a first level of compaction and/or matrix smoothing function, may also shield the matrix from cure energy transmitted by downstream components that will be discussed in more detail below.

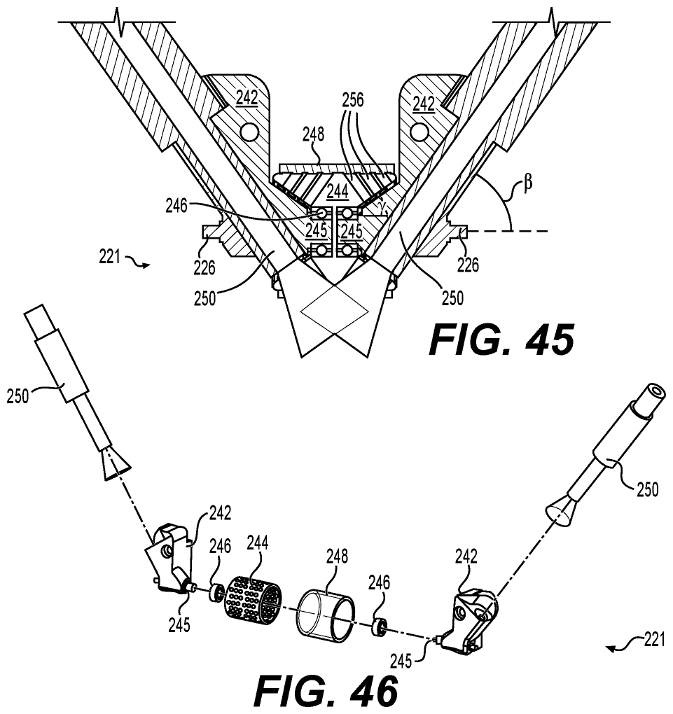

Subassembly 221 may include components that cooperate to further compact and/or wipe over the discharging material. In some applications, subassembly 221 may additionally trigger at least some curing of the matrix. In one embodiment, subassembly 221 provides about 4-5 times more compaction than subassembly 218. For example, subassembly 218 may provide about 0.75-1.0N (e.g., 0.9N) of compaction, while subassembly 221 may provide about 4.0-5.0N (e.g., 4.4N) of compaction. As shown in FIGS. 45 and 46, the components of subassembly 221 include, among others, a pair of oppositely arranged roller mounts 242, a roller 244 mounted to each of inwardly extending stub shafts 245 of mounts 242 via a pair of corresponding bearings 246, a cover 248 received over an annular surface of roller 244, and one or more (e.g., two) energy transmitters 250 that extend between one or more (e.g., the same or different) distal sources (e.g., simultaneously or independently activated light sources) and roller 244. In this embodiment, roller 244 is larger (e.g., has a greater diameter and/or contact surface area) than the roller/wiper of conditioner 234, although that may not always be the case (e.g., the sizes may be the same or reversed).

Roller mounts 242 may be mirrored opposites of each other, each having an outer bracket end for mounting subassembly 221 to subassembly 222, and stub shaft 245 extending inwardly from the bracket end. Bearings 246 may be pressed onto stub shafts 245. Pins 226 may be generally coaxial with stub shafts 245 and protrude axially outward from the bracket end of roller mounts 242. A passage or recess may be formed within each of roller mounts 242 to receive a corresponding transmitter 250. The passage may extend at an oblique angle β (shown in FIG. 45) from the outer bracket end of mount 242, axially inward and toward the material being passed over by roller 244. In one embodiment, the angle β of each passage and transmitters 250 may be about 30-90° (e.g., 30-65°). The angle β may help to focus the energy from transmitters 250 axially inward toward a general center of roller 244 and to an upper exposed surface of the material being passed over by roller 244. The angle β may also help cure an exposed side edge of the material. In some applications, the passages and transmitters 250 may additionally or alternatively be tilted forward at an oblique angle δ (see FIGS. 42 and 43), such that the energy from transmitters 250 is directed toward subassembly 222 and away from subassembly 218. In one embodiment, the angle δ of the passages and transmitters 250 is about 165-180°. The angle δ may help to focus the energy from transmitters 250 at or downstream of a nip point of roller 244 to avoid premature curing at a location not yet passed over by conditioner 234 and/or roller 244.

Roller 244 may have unique geometry that facilitates simultaneous compaction and curing of the material being passed over by subassembly 221. As shown in FIGS. 45 and 46, roller 244 may be generally cylindrical, having a center bore 254 formed therein to receive bearings 246 (referring to FIG. 46). Center bore 254, at each axial end of roller 244, may taper radially inward at an angle γ toward an outer edge of bearings 246. In one embodiment, angle γ is about 30-40° (e.g., 35°) and oriented generally orthogonal to the axes of transmitters 250 at outlets of transmitters 250 (referring to FIG. 45). One or more energy channels 256 may extend from the tapered inner surfaces of center bore 254 radially outward through an outer annular surface of roller 244 and axially inward toward an axial center of roller 244. Channels 256 may generally be aligned or parallel with the axis of passages 252 and transmitters 250 at the outlets of transmitters 250, such that energy may flow from transmitters 250 through channels 256 with little, if any, obstruction.

In the depicted embodiment, channels 256 are about 1.0-1.5 mm in diameter (e.g., 1.125 mm) and spaced about 1.25-1.75 mm (e.g., 1.5 mm) axis-to-axis. Three channels 256 are formed at each radial spoke of the tapered regions, with the axial locations being staggered between adjacent radial spokes to allow tighter nesting between adjacent channels 256. There are twenty spokes around the circumference of roller 244 in the embodiment of FIGS. 45 and 46.

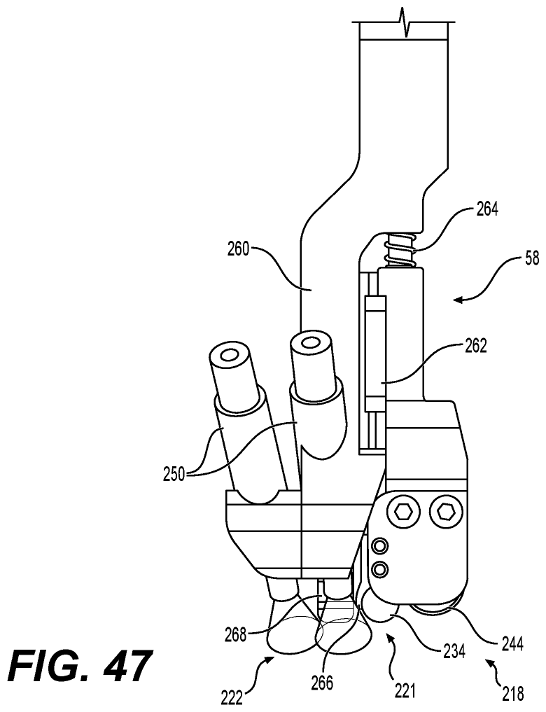

It is contemplated that roller 244 could have a simpler form, in some applications. For example, roller 244 could be a simple cylinder fabricated from an energy-transparent material (see FIG. 43). In these applications, because the energy from transmitters 250 may pass substantially uninterrupted through the transparent roller 244, channels and/or tapers may be omitted. Other, even simpler configurations are also possible. For example, roller 244 may be utilized without transmitters 250 directing cure energy therethrough (see FIGS. 47-54), if desired.

Cover 248 may be press fit over roller 244 and perform multiple functions. In one example, cover 248 provides a generally solid surface over the open ends of channels 256. This may reduce a likelihood of the material picking up a pattern from roller 244 and inhibit ingress of the material (e.g., of the matrix). In another example, cover 248 may provide a low-friction surface that reduces a likelihood of the matrix sticking to subassembly 221. In yet another example, cover 248 may help to diffuse or distribute some of the energy exiting channels 256 at a surface of the material being compacted and cured. Finally, cover 248 may be an inexpensive and easily replaced wear component that limits wear of the more permanent and expensive roller 244.

Subassembly 222 may include components that cooperate to further cure the discharging material. In one embodiment, subassembly 222 is configured to through-cure or complete curing of the matrix that was only triggered by subassembly 221. As shown in FIG. 41, subassembly 222 may include, among other things, a bracket 260 to which one or more energy transmitters 250 are connected. In the disclosed embodiment, two energy transmitters 250 are shown as arranged in mirrored opposition to each other (similar to the arrangement shown in FIG. 41 for subassembly 221). Energy transmitters 250 in subassembly 222 may be the same identical transmitters used in subassembly 221 or different, as desired. The outlets of transmitters 250 in subassembly 222 may be tilted inward relative to a symmetry plane that passes through the reinforcement R. It is also contemplated that the tips of transmitters 250 may additionally or alternatively be tilted in the fore-aft direction, if desired. Tilting of transmitters 250 toward subassembly 221 may allow for curing closer to the nip point of roller 244, which may increase an accuracy in reinforcement placement.

Bracket 260 may be generally U-shaped. Legs of the U-shape may be used to mount module 58 to the rest of head 16. An empty space between the legs of the U-shape may provide clearance for module 56 (see FIGS. 68-70).

In the embodiment of FIGS. 41-43, subassemblies 218-222 may be mounted to move together (e.g., relative to a remainder of head 16), as a single unit. It is contemplated, however, that one or both of subassemblies 218, 221 could alternatively or additionally move relative to subassembly 222. For example, as shown in FIG. 47, both of assemblies 218 and 221 may be slidingly connected to bracket 260 (e.g., via a guide and rail mechanism 262) and configured to move in a direction generally orthogonal to an underlying print surface and/or the normal travel direction of print head 16 during material discharge. A resilient member (e.g., a spring) 264 may bias subassemblies 218 and 221 away from the rest of print head 16 (e.g., downward, toward the underlying print surface). Transmitters 250, of the embodiment of FIG. 47, may all trail behind (i.e., not pass through or lead) assemblies 218 and 221. Conditioner 234, in this embodiment, may be a foam cylinder or block that does not rotate. A mount 266 may be provided to removably receive the foam cylinder and allow for quick (e.g., snap-out/snap-in) replacement after a period of wear.

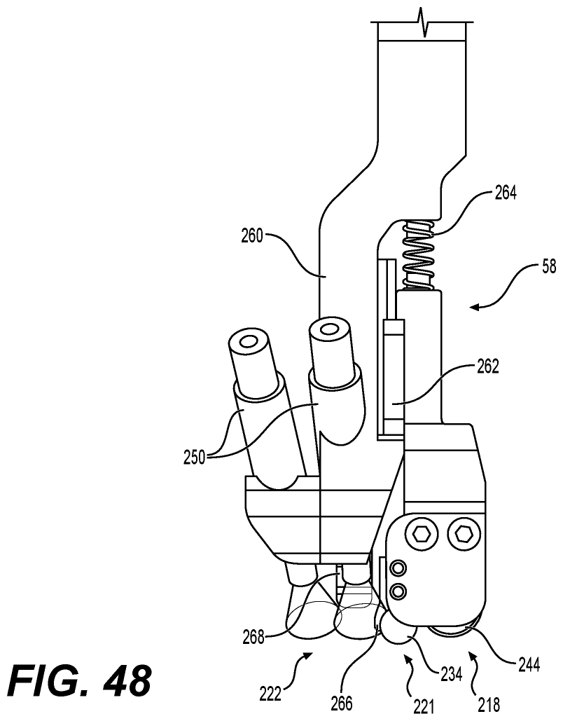

A stomper 268 may be provided within module 58, in some embodiments, for temporary use in anchoring a tag-end of a new path of material discharging from head 16. Stomper 268 may be generally transparent to the energy from transmitters 250 and configured to press downward on the tag-end of a reinforcement at print-start of the new path. In one embodiment, stomper 268 may be fabricated from an acrylic material and mounted rigidly to bracket 260. Assemblies 218 and 221 may be urged by spring 264 to normally extend downward past stomper 268 and be forced upward by engagement with an underlying surface to allow stomper 268 to press against the discharging material (e.g., via further downward motion of head 16 and bracket 260). After a period of pressing on the material, with cure energy simultaneously passing through stomper 268 and curing the tag-end of the new path in place, bracket 260 may be retracted until stomper 268 no longer contacts the material. Only subassemblies 218 and 221 may continue to contact the material at this time, for normal (e.g., non-startup) payout of the material (see FIG. 48). One or more (e.g., one pair of) transmitters 250 may direct cure energy through stomper 268 from opposing sides, while one or more (e.g., one pair of) transmitters 250 may expose the material to additional cure energy at a location downstream of both stomper 268 and subassembly 218. It should be notated that energy may not be directed through roller 244 in this embodiment. It is contemplated that stomper 268 may be omitted from the configuration of FIG. 48, if desired.

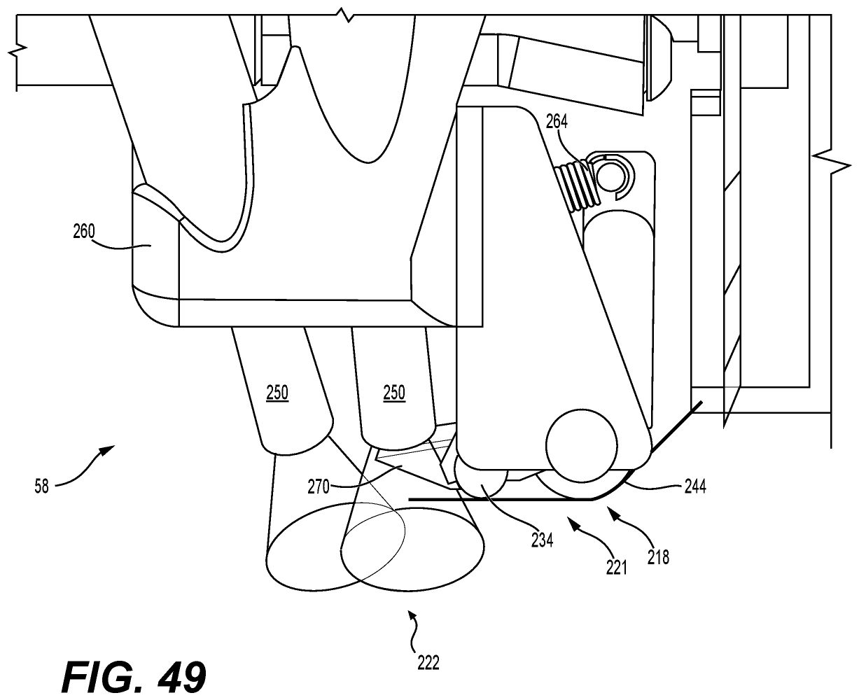

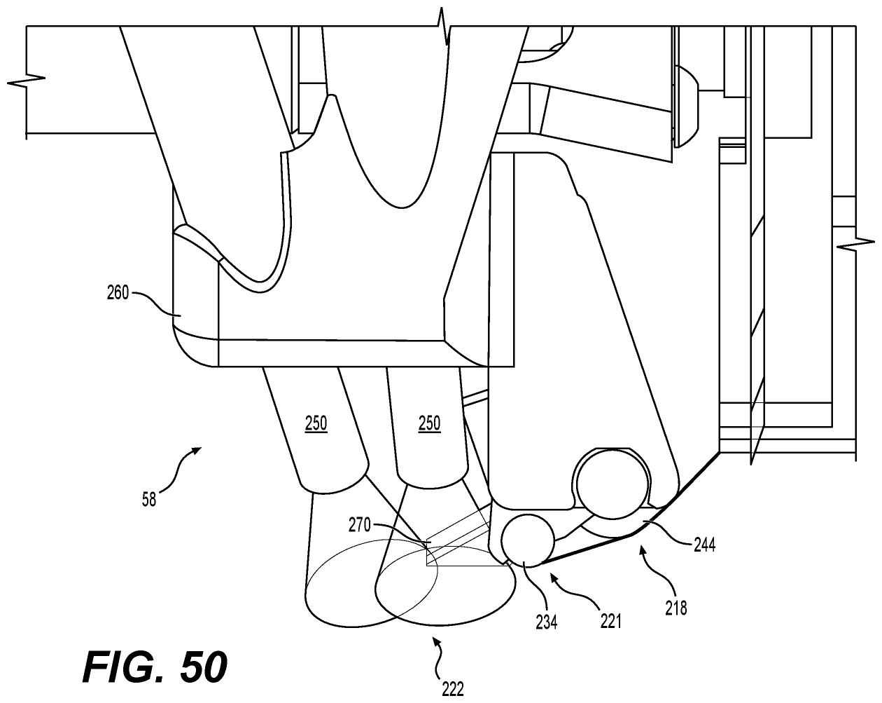

Module 58 of FIGS. 49 and 50 may be similar to module 58 of FIGS. 47 and 48. For example, assemblies 218 and 221 may be substantially identical, and a stomper 270 may be included that functions similar to stomper 268. In addition, cure energy may be directed through stomper 270 (e.g., only during anchoring or continuously during discharging) and only downstream of (i.e., not through) roller 244 of subassembly 218. However, in contrast to the embodiment of FIGS. 47 and 48, in the embodiment of FIGS. 49 and 50, subassembly 218 may be rigidly mounted to bracket 260. In addition, stomper 270 and subassembly 221 may together be moveably (e.g., pivotally) connected to bracket 260 independent of subassembly 218, and biased (e.g., by spring 264) to extend downward past subassembly 218 and first engage the discharging material as bracket 260 is extended (see FIG. 50). In this embodiment, further extension of bracket 260 may cause upwards pivoting of stomper 270 and subassembly 218 against the spring bias and away from the material until both of subassembly 218 and subassembly 221 (e.g., with or without stomper 270) are exerting pressure against the material (see FIG. 49).

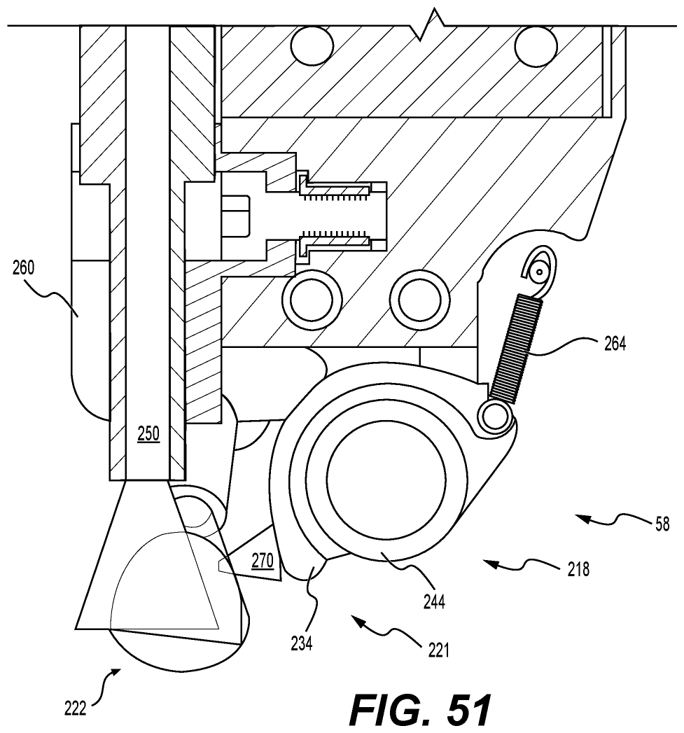

FIG. 51 illustrates an example of module 58 that is similar to module 58 of FIGS. 49 and 50, in that subassembly 221 and stomper 270 pivot together around subassembly 218. However, an orientation of spring 264 is different in the embodiment of FIG. 51 (e.g., extending from another component of head 16 at a leading side, instead of to bracket 260, and rotated about 270° relative to the embodiment of FIGS. 49 and 50).

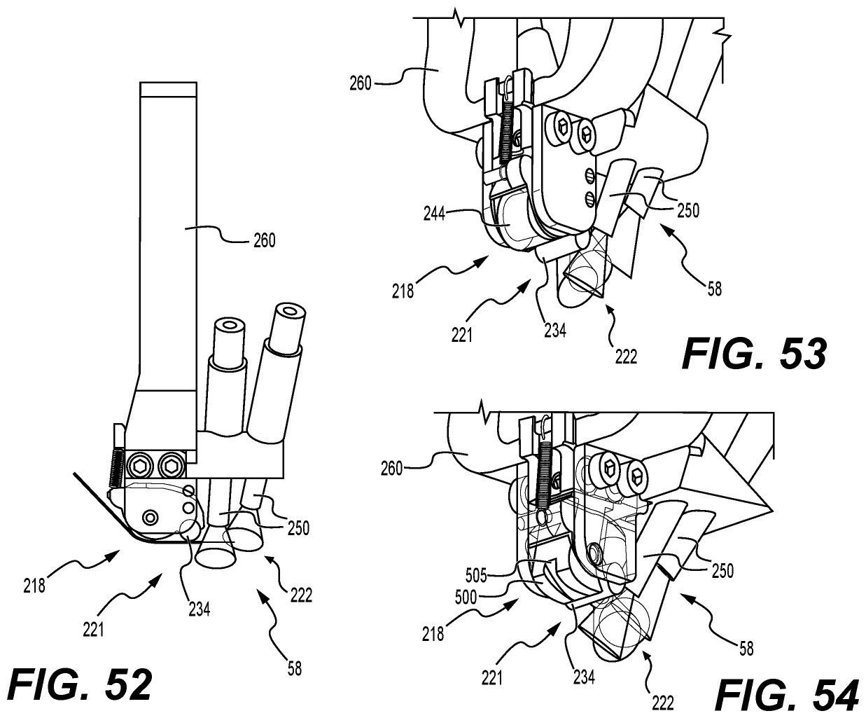

FIGS. 52, 53 and 54 illustrate modifications of module 58, compared to what is shown in FIG. 51. As show in FIGS. 52, 53 and 54, stomper 270 may be omitted and multiple stages of curing (e.g., two pairs of transmitters 250 in series) may be located downstream of both of assemblies 218 and 221. In FIGS. 52 and 53, subassembly 218 includes roller 244. However, in FIG. 54, roller 244 is replaced by a sliding device (e.g., a wiper) 500 that includes a centering or guiding slot 505 to receive the reinforcement from module 52. Accordingly, in the embodiment of FIG. 54, only sliding devices (i.e., no rolling devices) are utilized to compress and/or wipe over the wetted reinforcement. Transmitters 250 may be paired in spaced apart (i.e., leading/trailing) stages and extend from the same or different sources to provide the same or different intensities and/or types of cure energy. It is contemplated that only a single stage of transmitters 250 could alternatively be utilized, if desired.

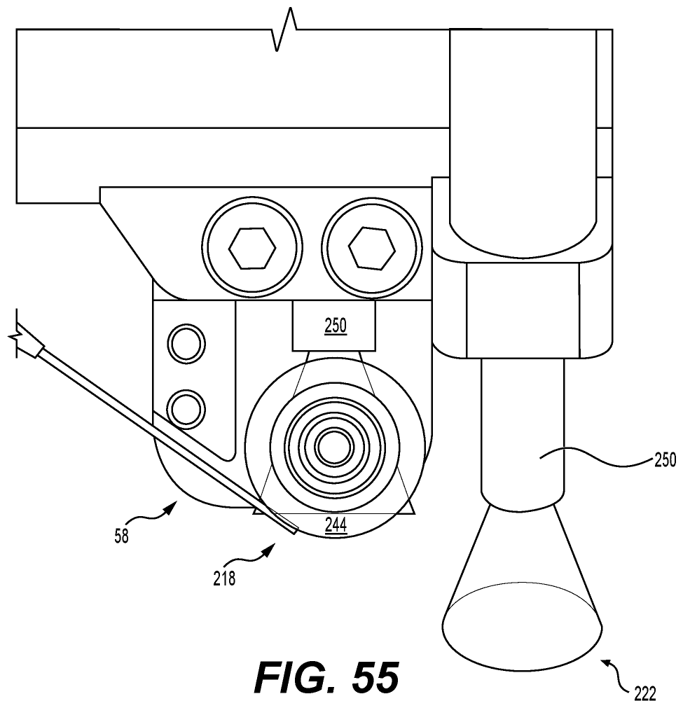

FIG. 55 illustrates yet another example of module 58. Like module 58 of FIG. 4, roller 244 shown in FIG. 55 may be cylindrical and configured passes cure energy (e.g., via a transparent annular surface) to the underlying material. In the embodiment of FIG. 55, however, the cure energy is directed radially from outside of roller 244 completely through the transparent annular surface of roller 244. Additional transmitters 250 may be located at a trailing side of subassembly 218 to further curing of the material, as desired. No stompers or wipers are included in the depicted embodiment, although such devices shown in the other examples could be added to the embodiment of FIG. 55 at locations upstream and/or downstream of roller 244, if desired.

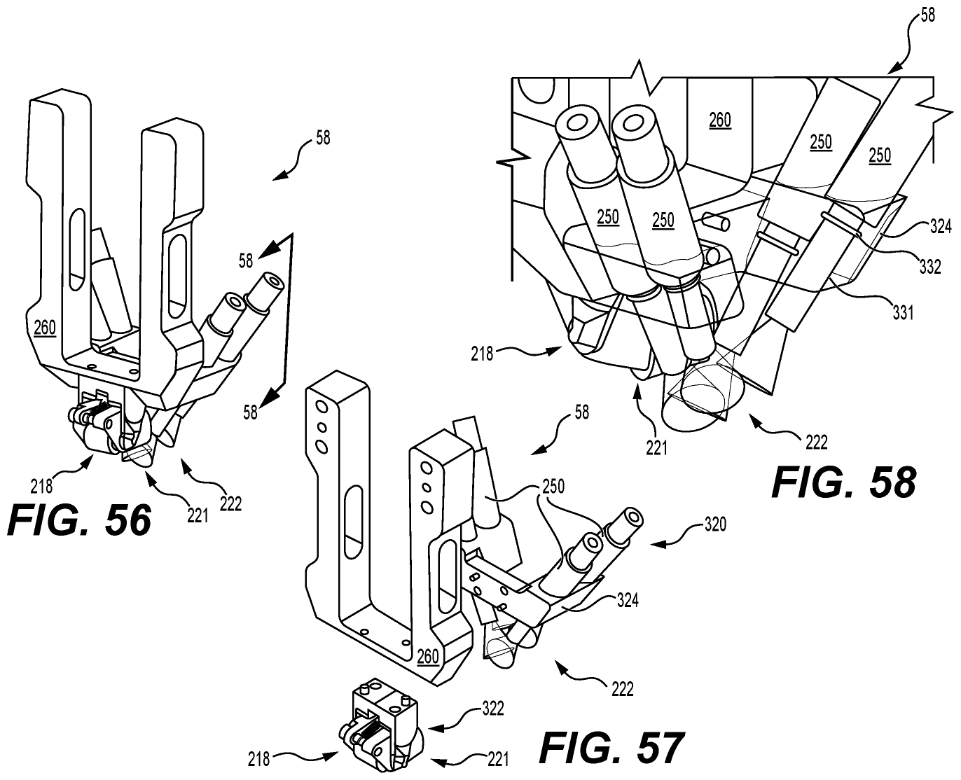

A final embodiment of module 58 is illustrated in FIGS. 56, 57 and 58. As shown in these figures, module 58 of this embodiment may be similar to the embodiment of FIGS. 52-54. For example, module 58 may still be broken down into multiple (e.g., two, three, or more) subassemblies, including a trailing or curing subassembly 222 and one or more leading or conditioning subassembly 218, 221 that leads curing subassembly 222. Each of these subassemblies may be connected to bracket 260 (e.g., via one or more locating pins and/or other fasteners) to form module 58 and move together to wipe over (e.g., smooth, distribute matrix, etc.), compact, and/or cure the material discharging from module 52.

As shown in FIG. 58, curing assembly 222 may include, among other things, an adapter 324 configured to hold at least two (e.g., two pairs of) of oppositely arranged energy transmitters 250. In the disclosed embodiment, transmitters 250 are light pipes that extend from one or more remote cure sources (e.g., light sources such as lasers, UV lights, etc.—not shown) to locations near the composite material being compacted by subassembly 222. Transmitters 250 may be held within corresponding bores 331 of adapter 324 via resilient members (e.g., o-rings) 332 that contract during installation and expand into corresponding annular channels within bores 331 upon full insertion.

Adapter 324 may be generally C-shaped (e.g., when viewed from above in the perspective of FIG. 57), having a spine and legs that extend in the same direction from opposing ends of the spine. Bores 331 may be formed within the legs of the C-shape and inclined toward a center plane of symmetry passing through module 58 (i.e., such that tip our outlet ends of transmitters 250 extending through bores 331 are closer to the discharging material than bores 331). The angle of this incline may be substantially similar to the angle β shown in FIG. 45, such that an internal angle between transmitters 250 may be about 50-120°.

It is also contemplated that transmitters 250 may be tilted in a direction of print head travel, similar to what is shown in FIG. 42. However, in contrast to the embodiment of FIG. 42, transmitters 250 may be tilted such that their outlet ends are closer to conditioner 234. For example, transmitters may be tilted relative to a normal of the surface being compacted by an angle δ that is about 90-135°. In some embodiments, the trailing set of transmitters 250 may be tilted by a greater angle, such that the corresponding areas of exposure on the compacted material overlap by a greater amount.

As disclosed above, the embodiment of FIGS. 56-58 includes a pair of transmitters 250 mounted within each leg of the C-shape. In this embodiment, the leading transmitter 250 of the pair may extend a greater distance in a z-direction toward the discharging material compared to the trailing transmitter 250 (see FIG. 58). This may allow for a greater intensity of cure from the leading transmitter 250 and a greater area of cure from the trailing transmitter 250. The staggard mounting distance of transmitters 250 may also enhance clearance at the discharge end of head 16, allowing for fabrication within tighter constraints.

In some embodiments, mounting of transmitters 250 (and/or other components) at the discharge end of head 16 may be affected by the matrix being discharged and/or curing of that matrix. For example, mounting using fasteners can be problematic when the matrix coats the fasteners and is cured. For this reason, transmitters 250 may be mounted in a fastener-less manner.

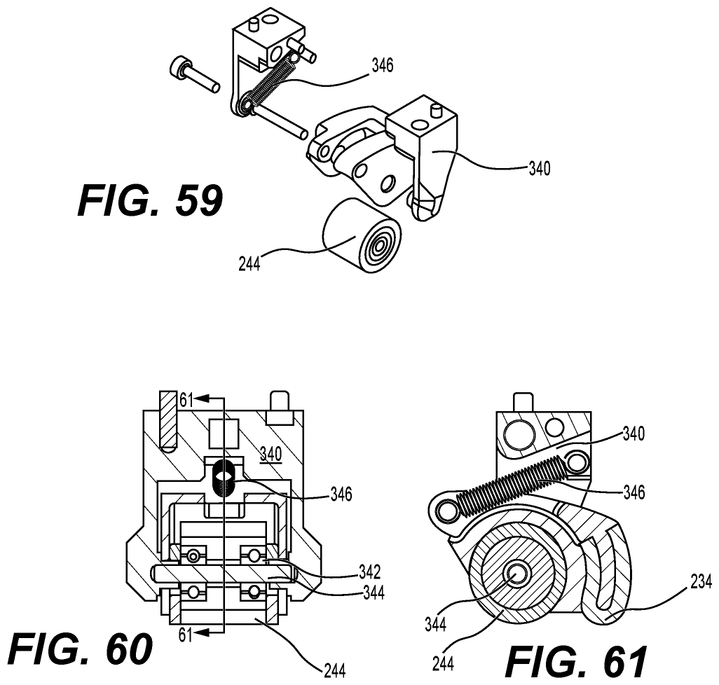

As shown in FIGS. 59, 60 and 61, a compacting roller 244 and a sliding or wiping conditioner 234 may be rotationally and/or pivotally mounted within a common frame (e.g., a 2-piece frame) 340 via one or more bearings 342 and a shaft 344 passing through bearings 342 into frame 340. In the disclosed embodiment, conditioner 234 trails roller 244 relative to a normal travel direction of head 16. It should be noted, however, that this relationship could be reversed, if desired. Conditioner 234 may be mounted to pivot about roller 244 and biased (e.g., via a spring 346) toward the material being discharged from head 16. An outer surface of roller 244 may be fabricated from a relatively harder and stiffer material than an outer surface of conditioner 234, allowing for roller 244 to provide a primary or greater compacting force than conditioner 234 and for conditioner 234 to deform somewhat and provide a primary wiping-of-matrix function. It should be noted, however, that conditioner 234 may still provide some compaction to the material passing thereby, and that roller 244 may still provide some smoothing of the matrix, if desired. Conditioner 234, in addition to providing the matrix smoothing function and/or some compaction, may also shield the matrix from cure energy passing from trailing transmitters 250 to the material being compacted/smoothed. In this embodiment, roller 244 may have a larger diameter cross-section than wiper 234 (e.g., 0-5 times as large) to allow for the desired functionality without sacrificing form factor. Axial lengths, however, should be nearly identical for each of roller 244 and wiper 234 (e.g., 1.5-3 times an applied with of the reinforcement). It should be noted that a smaller diameter roller 244 may allow for higher resolution in printing, while a larger diameter conditioner 234 may provide a greater compliance and therefor better wiping. The axial lengths of these components may allow for a desired pressure and resolution, without risking that the reinforcement will walk off the ends of these components.

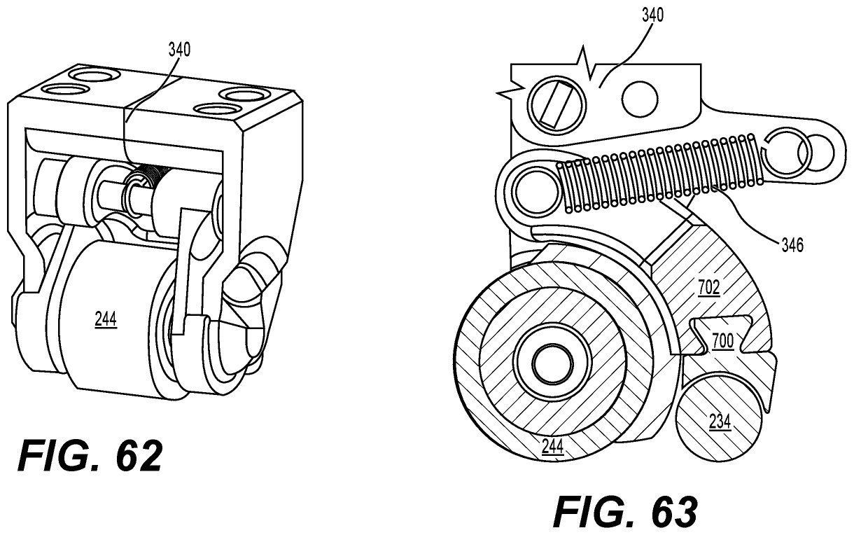

FIGS. 62 and 63 illustrate an alternative mounting arrangement of compacting roller 244 and conditioner 234. In this embodiment, conditioner 234 may be configured for simple and quick replacement after a period of wear. For example, conditioner 234 may include a dovetail projection 700 configured to be received within a corresponding recess of a pivot arm 702. Spring 346 may connect to an end of arm 702 opposite conditioner 234.

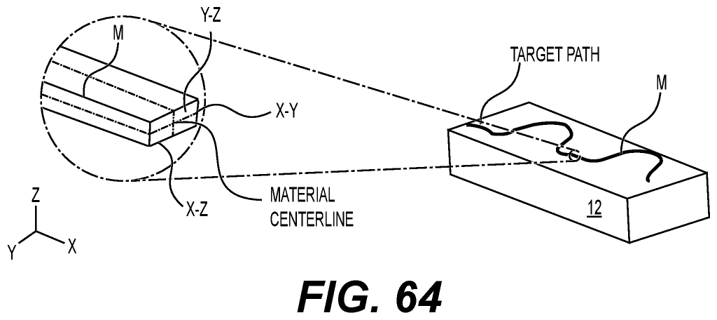

It should be noted that the specific type, number, configuration, and arrangement of components in module 58 may affect the way in which print head 16 is controllably steered during material discharge to accurately fabricate structure 12. For purposes of explanation, FIG. 64 illustrates a virtual model of structure 12 to be fabricated by system 10 (e.g., a model created by a user of system 10 via a conventional CAD system). The model, along with known characteristics (e.g., a size and shape) of the material M to be used in the fabrication, may be used to generate one or more target paths in which the material should be deposited to create structure 12. When the material is deposited accurately in the target path, the fabricated structure 12 substantially matches the virtual model. In the disclosed embodiment, a centerline or center axis of the deposited material is intended to lie in the target path at all locations along the target path.

In the embodiment depicted in FIG. 64, the material discharging from module 52 has a generally rectangular shape, with a width dimension in a Y-direction, a thickness dimension in a Z-direction, and a length dimension in an X-direction. The width of the material may be greater than the thickness. The length may vary between paths and be dictated by the model and controlled by selectively severing the material at different locations. The centerline may be defined by intersection of y-z and x-z planes at each point along the path. As will be described in more detail below, head 16 should be moved and steered about a tool center point (TCP) that is coincident with the centerline or center axis of the material. The TCP may be located differently, depending on the configuration of module 58.

It should be noted that, while the above description anticipates a material that is discharged with a rectangular cross-section, material having another shape may also be possible. For example, material having a circular or ellipsoidal cross-section may alternatively be discharged from nozzle 168D of wetting module 52 (see, for example, FIG. 33). However, even in these embodiments, after compaction by module 58 of the material originally discharged with a circular cross-section against an underlying surface, the cross-section may be distorted to have a more rectangular shape. Accordingly, the above description may still be valid, regardless of the shape of the material as it is originally discharged. For similar reasons, the following description also applies to most materials, regardless of the discharge shape.

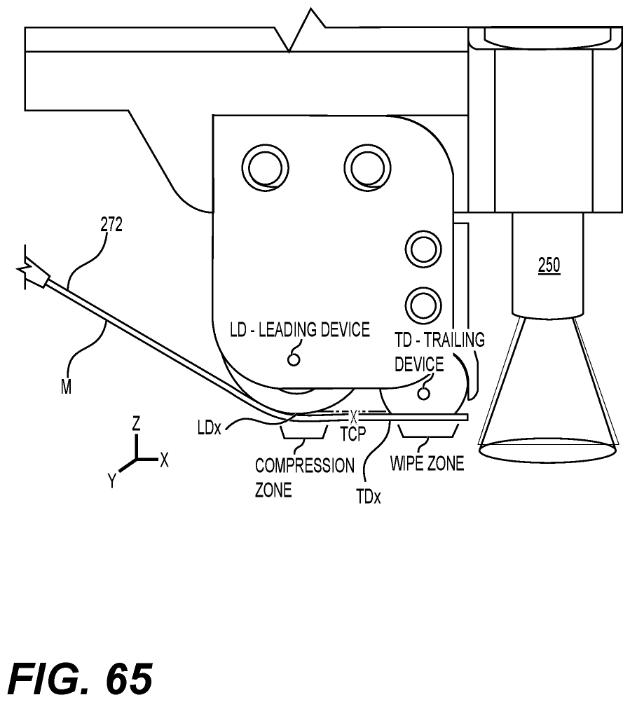

FIG. 65 illustrates the location of the TCP to be used with the module-58 configuration having a leading device (LD) that first moves (e.g., rolls) over and compacts the material discharging from module 52, followed by a trailing device (TD) that moves (e.g., slides) over and wipes the material. It should be noted that some wiping may be caused by the LD and some compacting may be caused by the TD, if desired. Neither the LD or the TD include an integral transmitter 250 in this embodiment. That is, only transmitter(s) 250 that trail behind the TD are included. In this embodiment, the TCP is located between an LDx (e.g., an x-coordinate of the LD axis) and a TDx (e.g., a leading edge of a wiper zone associated with the TD in the x-direction), and closer to the LDx than the TDx. The TCP may not be within a pressure zone of the LD (e.g., a zone in which the LD is exerting a compacting pressure through the material) or within a wipe zone of the TD. The TCP is located within a Y-Z plane encompassing a discharge nozzle axis 272 of module 52 and is orthogonal to an underlying surface at the TCP. The TCP is located a ½-thickness of the material (e.g., after compression by the LD) below a Y-X plane encompassing the wipe surface of the TD and a tangent of the LD. During material discharge with this configuration, a Y-axis of the LD is maintained parallel to the underlying surface at the TCP and an upper or lower surface of the rectangular shape of the material. In some embodiments, a final rotational axis of support 14, commonly known as a J6-axis, may be maintained normal to the underlying surface at the TCP and the upper or lower surface of the rectangular shape of the material. Axis 272 may be angled away from the J6-axis by about 30-60° (e.g., about 45°).

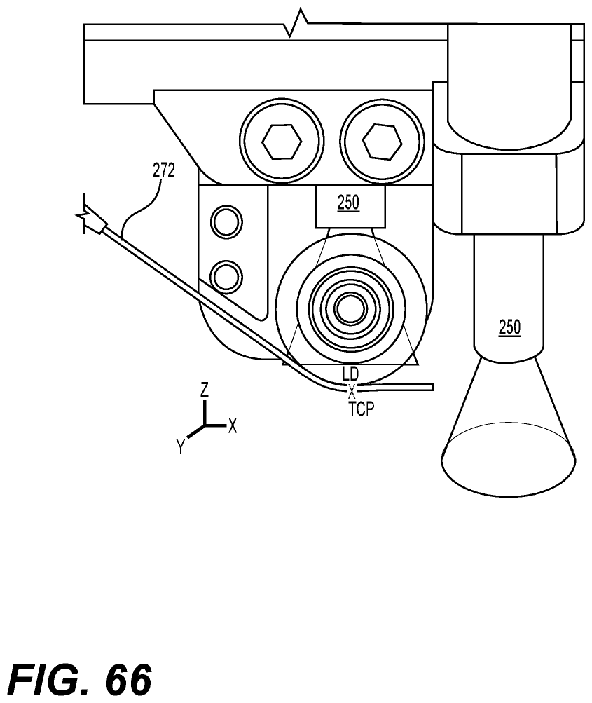

FIG. 66 illustrates the location of the TCP to be used with the module-58 configuration having only a leading device (LD) that moves (e.g., rolls) over and compacts the material discharging from module 52 (i.e., a configuration without a trailing device that moves over and compacts/wipes the material). It should be noted that some or only wiping (e.g., with some or no compacting) may be caused by the LD, if desired. The LD may include one or more integral transmitter(s) 250, additional trailing transmitter(s) 250, only trailing transmitter(s) 250, or no transmitters at all. In these embodiments, the TCP is located within the compression/wipe zone of the LD (e.g., at a point in the x-direction of highest pressure—the nip point). In some embodiments, the TCP may be located a distance (e.g., 1-10 times a thicknesses of the material) forward of the nip point, but still within the compression/wipe zone. As with all embodiments, the TCP is located within the Y-Z plane encompassing the discharge nozzle axis of module 52, and located a ½-thickness of the material (e.g., after compression by LD) below the Y-X plane encompassing the tangent of the LD that is parallel with the underlying surface. During material discharge with this configuration, a Y-axis of the LD is maintained parallel to an underlying surface at the TCP and an upper or lower surface of the rectangular shape of the discharging material. In some embodiment, the J6-axis may be maintained normal to underlying surface at the TCP and the upper or lower surface of the rectangular shape. Axis 272 may be angled away from the J6-axis by about 30-60° (e.g., about 45°).

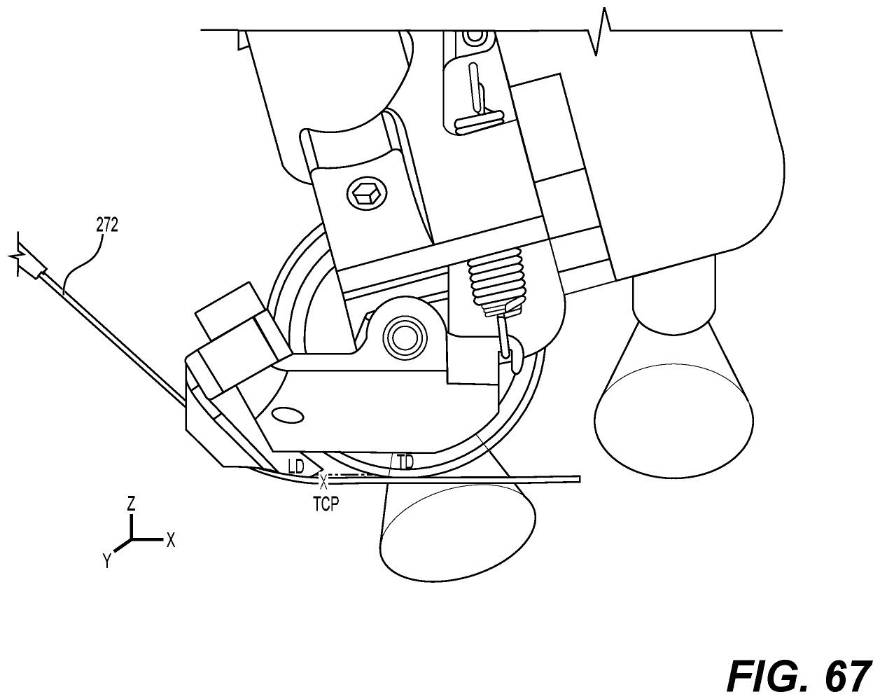

FIG. 67 illustrates the location of the TCP to be used with the module-58 configuration having a leading device (LD) that first moves (e.g., wipes) over the material discharging from module 52, followed by a trailing device (TD) that moves (e.g., rolls) over and compacts the material. It should be noted that some compacting may be caused by the LD and some wiping may be caused by the TD, if desired. The TD may include an integral transmitter 250 in this embodiment. In this embodiment, the TCP is located between an LDx (e.g., a trailing edge of the wipe surface) and a TDx (e.g., a leading edge of the pressure zone), and closer to the LDx than the TDx. The TCP may not be within the wipe zone of the LD or the pressure zone of the TD. The TCP is located within a Y-Z plane encompassing a discharge nozzle axis 272 of module 52 and is orthogonal to an underlying surface at the TCP. The TCP is located a ½-thickness of the material (e.g., after compression by TD) below a Y-X plane encompassing the wipe surface of the LD and a tangent of the TD. During material discharge with this configuration, a Y-axis of the TD is maintained parallel to the underlying surface at the TCP and an upper or lower surface of the rectangular shape of the discharging material. In some embodiment, a final rotational axis of support 14, commonly known as a J6-axis, may be maintained normal to the underlying surface at the TCP and the upper or lower surface of the rectangular shape. Axis 272 may be angled away from the J6-axis by about 30-60° (e.g., about 45°).

A position of module 58 relative to print head 16 and/or a pressure applied by module 58 to the discharging material may be selectively adjusted in a local manner. For example, as shown in FIG. 68, module 58 (together with module 56, in some embodiments), may be movingly connected to lower plate 26 via a carriage 301 and a rail 303. Carriage 301 may be rigidly connected to bracket 260, while rail 303 may be rigidly connected to lower plate 26. Carriage 301 may be configured to slide or roll along rail 303 in a direction generally parallel to the J6 axis and orthogonal to a surface of structure 12 at the TCP.

One or more actuators may be controlled to selectively cause carriage 301 (along with module 58) to slide relative to rail 303. For example, a first actuator 305 may exert an upward force, while a second actuator 306 exerts a downward force. When the upward force exceeds the downward force and a weight of the connected modules, carriage 301 may move upwards, and vice versa. In one application, the upward force is maintained constant and only the downward force is varied to achieve upward or downward motion and a corresponding pressure exerted by module 58 on the material. Although two single-acting pneumatic cylinders are shown as acting at opposing transverse sides of carriage 301, it is contemplated that other types and/or numbers of actuators (e.g., double-acting, electric or hydraulic actuator(s)) could be utilized and located at opposing transverse sides or the same side, if desired. It should be noted that the two single-acting cylinders oriented in opposition to each other may provide greater and/or more refined control over the exerted pressure. A sensor 309 may be detect a position of module 58 relative to the rest of head 16 and generate a corresponding signal used to responsively regulate operation of actuator(s) 304, 306.

A range of travel of module 58 may include the range of travel of carriage 301 along rail 303 and a range of travel of subassembly 218 relative to bracket 260 (see FIGS. 47 and 48). For example, bracket 260, being connected to carriage 301, may travel a first distance that is equal to a length of rail 303 and/or a travel distance of actuator 306, and subassembly 218 may travel a second distance associated with rail and guide mechanism 262. In one embodiment, the second distance may be about ½ to ¼ of the first distance.

In the embodiment of FIGS. 47 and 48, subassembly 218 may normally be biased along mechanism 262 toward a fully extended position by spring 264. At startup of a discharging event, carriage 301 may be extended until subassembly 218 engages the discharging material and is pushed back upward against the bias of spring 264 to a location about midway between the fully extended and fully retracted positions. Carriage 301 may then be locked at this extension position, and head 16 may thereafter be moved along predefined tool paths to discharge material. Subassembly 218 may be allowed to extend or retract away from the midway-location via mechanism 262 with or against the bias of spring 264 during material discharge, as necessary to accommodate an uneven underlying surface and/or provide a relatively consistent amount of pressure against the material.

It is contemplated that the midway-setting operation of subassembly 218 described above may be implemented as often as desired. For example, subassembly 218 may be reset to the midway location of carriage 301 at start of each new path, at start of each new layer, partway through a path, partway through a layer, on a periodic basis, after a minimum length of material has been discharged, etc.

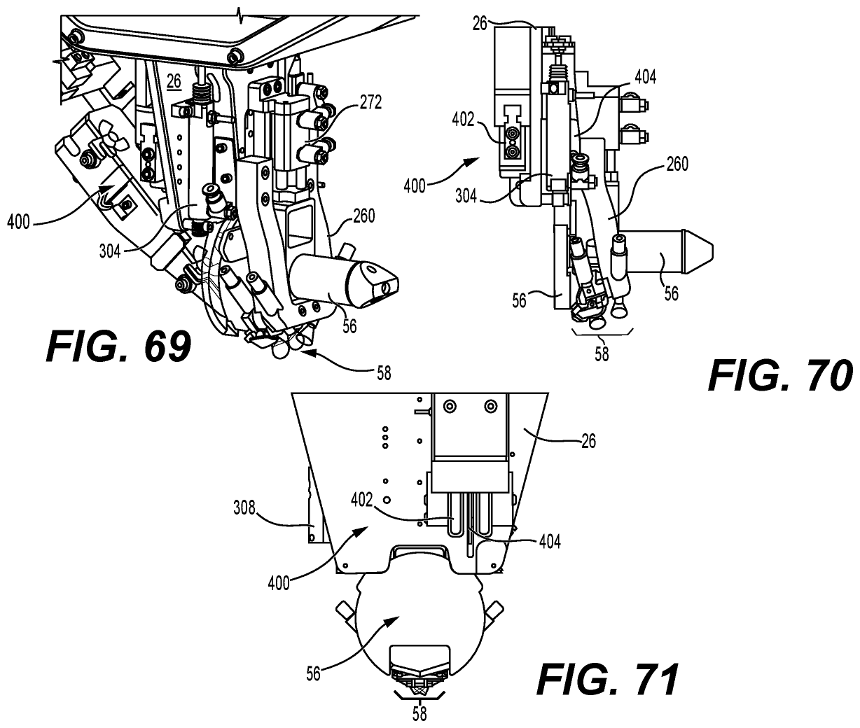

Locking of carriage 301 relative to the rest of print head 16 may be achieved with a position locker 400 illustrated in FIGS. 69, 70 and 71. Locker 400 may include at least an actuator 402 that is affixed to plate 26 and configured to operatively engage a moveable portion of carriage 301 and/or module 58 to lock carriage 301 to plate 26. In the disclosed embodiment, an extension 404 is also included that extends from carriage 301 to actuator 402 (e.g., through plate 26). Extension 404 is rigidly connected to carriage 301, and actuator 402 may be selectively activated to halt movement of carriage 301 via engagement with extension 404. Although extension 404 is shown as a plate that extends through a corresponding slot in plate 26, other configurations (e.g., rods, tracks, chains, etc.) may also be possible. Further, although actuator 402 is illustrated as a pneumatic clamp that sandwiches extension 404 between opposing friction members, other configurations are also possible.

It is contemplated that, rather than locking the motion of carriage 301 during all discharge events, carriage 301 may be locked at only select times. For example, carriage 301 may be locked during a fiber-severing event, during discharge of material around a curving trajectory, during transition from supported printing to free-space printing, during printing of only specific layers within structure 12, and/or during printing of only accuracy-critical areas of structure 12.

Locking carriage 301 (and in turn the vertical motion of module 58) during a severing event may help to reduce reactionary motion of module 58 caused by activation of module 56. That is, because of the connected relationship between modules 56 and 58, when module 56 is activated to move downward toward the material (e.g., by actuator 272—see FIG. 69), a reverse or upwards force may be reactively generated within module 58, causing module 58 to lift away from the material. The opposite may also be true. Locking of carriage 301 to the rest of print head 16 via locker 400 may reduce these reactionary responses.

Locking carriage 301 (and in turn the motion of module 58) during discharge along a curving trajectory may help to reduce a buildup of material at corners within structure 12. That is, during such discharging, the material tends to roll and/or fold upon itself due to its rectangular cross-section. If unaccounted for, this could undesirably increase a thickness of the material at the corners. By locking carriage 301, module 58 may exert a greater pressure on the material at the corners (by resisting being pushed away from the thicker material), thereby helping to squish the material to a desired thickness.

Locking carriage 301 (and in turn the motion of module 58) during transition from supported printing to free-space printing may reduce discontinuities at the transition location. That is, if module 58 were free to move at the transition location, module 58 would immediately be spring-biased to extend to its fullest extent after moving off a supported surface due to the sudden lack of reactionary forces. By locking module 58 at the transition location, module 58 should remain at a relatively constant extended position, even though the reactionary forces may still fall away when moving from supported to unsupported printing.

Locking carriage 301 (and in turn the motion of module 58) at specified layers and/or critical features of structure 12, accuracy in the shape and/or size of structure 12 may be improved. That is, not all layers of structure 12 need to be accurately placed, and a thickness of these layers may be allowed to grow uncontrollably to some extent. However, to help ensure that an overall shape and/or size of structure 12 matches a desired profile (e.g., at a mating interface), carriage 301 may be locked during fabrication of particular layers and/or features to force those layers and/or features to conform to design limitations. Locking may be performed periodically (e.g., ever other layer, every 5^{th} layer, every 10^{th} layer, etc.) and/or at strategic locations of critical dimensions.

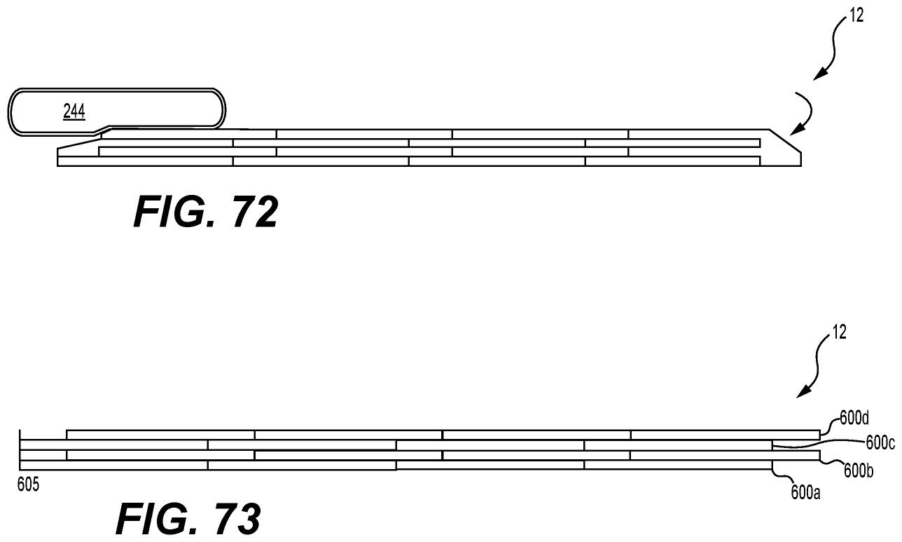

FIGS. 72, 73 and 74 illustrate a method of fabricating structure 12 utilizing any of the disclosed embodiments. FIGS. 72-74 will be discussed in more detail below to further illustrate the disclosed concepts.

### INDUSTRIAL APPLICABILITY

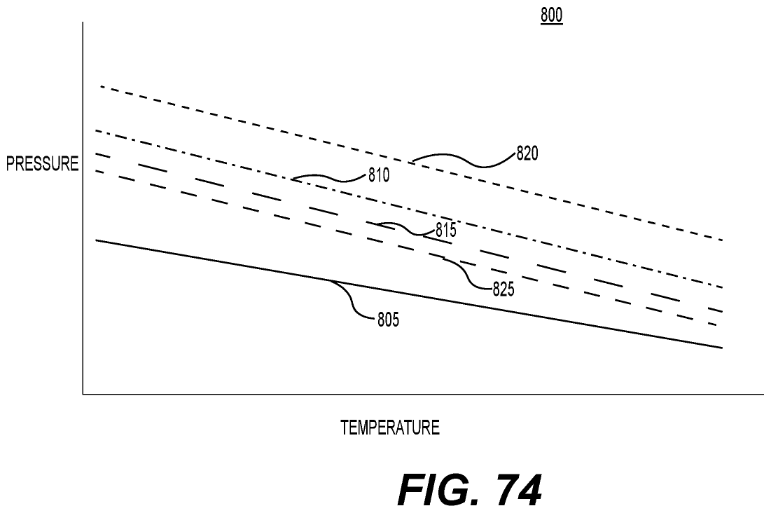

The disclosed system and print head may be used to manufacture composite structures having any desired cross-sectional size, shape, length, density, and/or strength. The composite structures may include any number of different reinforcements of the same or different types, diameters, shapes, configurations, and consists, each coated with a common matrix. Operation of system 10 will now be described in detail with reference to FIGS. 1-74.

At a start of a manufacturing event, information regarding a desired structure 12 may be loaded into system 10 (e.g., into controller 20 that is responsible for regulating operations of support 14 and/or head 16). This information may include, among other things, a size (e.g., diameter, wall thickness, length, etc.), a shape, a contour (e.g., a trajectory), surface features (e.g., ridge size, location, thickness, length; flange size, location, thickness, length; etc.) and finishes, connection geometry (e.g., locations and sizes of couplers, tees, splices, etc.), location-specific matrix stipulations, location-specific reinforcement stipulations, compaction requirements, curing requirements, pressure settings, viscosities, flowrates, etc. It should be noted that this information may alternatively or additionally be loaded into system 10 at different times and/or continuously during the manufacturing event, if desired.

Based on the component information, one or more different reinforcements and/or matrixes may be selectively loaded into head 16. For example, one or more supplies of reinforcement may be loaded onto creel 19 (referring to FIGS. 1-5) of module 44, and one or more cartridges 110 of matrix may be placed into vessel 112 of module 46 (referring to FIG. 9).

The reinforcements may then be threaded through head 16 prior to start of the manufacturing event. Threading may include passing the reinforcement from module 44 around portions of module 48 and through module 50. The reinforcement may then be threaded through module 52 and wetted with matrix. Module 52 may then move to an extended position to place the wetted reinforcement under module 58. Module 58 may thereafter be extended to press the wetted reinforcement against an underlying layer. After threading is complete, head 16 may be ready to discharge matrix-coated reinforcements.

At a start of a discharging event, one or more cure sources of module 58 may be activated, module 50 may be deactivated to release the reinforcement, and head 16 may be moved away from a point of anchor to cause the reinforcement to be pulled out of head 16 and at least partially cured. This discharge may continue until discharge is complete and/or until head 16 must move to another location of discharge without discharging material during the move.

During discharge of the wetted reinforcements from head 16, module 58 may move (e.g., roll and/or wipe) over the reinforcements. A pressure may be applied against the reinforcements by module 58, thereby compacting the material. The cure source(s) of module 58 may remain active during material discharge from head 16 and during compacting, such that at least a portion of the material is cured and hardened enough to remain tacked to the underlying layer and/or to maintain its discharged shape and location. In some embodiments, a majority (e.g., all) of the matrix may be cured by exposure to energy from module 58.

The component information may be used to control operation of system 10. For example, the reinforcements may be discharged from head 16 (along with the matrix), while support 14 selectively moves head 16 in a desired manner during curing, such that an axis of the discharging material follows a desired trajectory (e.g., a free-space, unsupported, 3-D trajectory) and forms structure 12. In addition, module 46 may be carefully regulated by controller 20 such that the reinforcement is wetted with a precise and desired amount of the matrix.

As discussed above, during payout of matrix-wetted reinforcement from head 16, modules 44 and 48 may together function to maintain a desired level of tension within the reinforcement. It should be noted that the level of tension could be variable, in some applications. For example, the tension level could be lower during anchoring and/or shortly thereafter to inhibit pulling of the reinforcement during a time when adhesion may be lower. The tension level could be reduced in preparation for severing and/or during a time between material discharge. Higher levels of tension may be desirable during free-space printing to increase stability in the discharged material. Other reasons for varying the tension levels may also be possible.

FIGS. 72 and 73 illustrate a method of fabricating structure 12. As shown in these figures, structure 12 may be fabricated from a plurality of layers 600 (e.g., 600a, 600b, 600c and 600d) that are discharged adjacent each other (e.g., on top of each other) in an overlapping manner. Ideally, the outermost paths of each layer 600 would terminate at an exact boundary edge 605. However, due to placement errors between layers 600 that are not otherwise accounted for, the boundary edge 605 is generally staggard somewhat and results in a rough outer surface.

To improve this outer surface, the transversely outermost paths may intentionally be cantilevered by a desired amount at every other layer. In one embodiment, the non-cantilevered paths extend to a first location and the cantilevered paths are initially placed to extend past the first location (e.g., partway or all the way to edge 605). During subsequent compaction of the cantilevered paths by subassembly 218 and/or 221, the cantilevered paths are pressed downward and curve inward to a final resting position at an intended location (e.g., at boundary edge 605). It is contemplated that the cantilevering may be accomplished by staggering the paths of a first layer relative to the paths of an adjacent layer by an amount less than a width of each path (e.g., by about ¼ to ½ of the width). This staggering may be accomplished throughout an entire cross-section of every other layer or only within paths (e.g., 1-10 paths) that lie near the boundary edge.

It should be noted that proper operation of system 10 may rely on the materials (e.g., the reinforcement and the matrix) being used within system 10 having established quality parameters. For example, the matrix should have an expected viscosity and formula. However, in some instances (e.g., during extended periods of time between manufacture and use, when improperly mixed or stored, etc.), it may be possible for viscous oligomers and/or solid particles to settle out of the matrix or agglomerate. This may cause the viscosity and/or formula of the matrix to deviate from expected values. Unless otherwise accounted for, these changes could cause system 10 to malfunction and/or for structure 12 to have properties below expected values.

One way to help ensure the materials being used within system 10 have quality parameters within acceptable limits may be to compare operations of modules 46 and 52 with expected operations once system 10 has been loaded with a particular cartridge 110 of matrix. For example, matrix may be supplied from module 46 to module 52 in an amount and/or at a rate the provides a desired operating pressure within module 52 for a given temperature of the matrix. That is, as a pressure measured by sensor 214 (referring to FIGS. 13 and 21) within module 52 falls below a low limit, additional matrix is pumped (or pumped at a higher rate) from module 46 into module 52. Likewise, as the pressure measured by sensor 214 rises above a high limit, less matrix is pumped (or pumped at a lower rate) from module 46 into module 52. During normal operation, when the matrix being used within system 10 has acceptable quality parameters, a regulated air pressure within module 46 should produce an expected and corresponding pressure within module 52 for the given temperature of the matrix. As the quality parameters of the matrix deviate from acceptable values, the relationship between regulated air pressure in module 46 and resulting matrix pressure within module 52 may likewise deviate.

Accordingly, controller 20 may have stored in memory one or more maps that relate the regulated air pressure to an expected matrix pressure for a given matrix parameter (e.g., viscosity, age, formula, temperature, etc.). The map may be in the form of an equation, a table, a graph, etc. An exemplary map 800 that can be used for this purpose is shown in FIG. 74. Map 800 may be a graph having a first (e.g., x) axis that represents a temperature of the matrix inside of module 52, and a second (e.g., y) axis that represents pressure (e.g., the actual air pressure in module 48—curve 805, an expected air pressure in module 48—curve 810, and/or the sensed matrix pressure in module 52—curve 815). One or more thresholds (e.g., a high-threshold 820 and a low-threshold 825) may bound curve 810. In one embodiment, high- and low-thresholds 820, 825 may be offset from curve 810 by equal amounts. In another embodiment, however, high-threshold 820 may be offset by an amount greater than low-threshold 825. These unequal offsets may account for changing system friction and help to avoid false alarms.

Controller 20 may selectively reference a temperature of the matrix (e.g., as measured via sensor 184) and the actual air pressure required with module 48 to produce the regulated matrix pressure within module 52 with thresholds 820 and 825. As long as the actual air pressure within module 48 falls between thresholds 820 and 825 for the given temperature, controller 20 may conclude that the matrix has the required quality parameters. Otherwise, controller 20 may determine that the matrix should not be used and selectively trigger a responsive action (e.g., cause system 10 to shut down and/or to generate an alert).

It is contemplated that a discharge rate of material from module 52 could cause instabilities in the pressure relationship discussed above. To mitigate effects of this possibility, controller 20 may, in some embodiments, only make the above-described comparison during particular operations (e.g., during cutting) when material is not being discharged or discharged at a rate known to provide a stable pressure relationship.

It is contemplated that the above-described comparison between pressures of modules 48 and 52 could additionally or alternatively be used to detect and/or diagnose system failures that are not related to materials. For example, a rate of deviation between expected and actual pressures (e.g., sudden changes not associated with material settling) could be used to diagnose clogging and/or pinching of a conduit extending between modules 48 and 52, binding or another mechanical failure of module 48, etc.

It will be apparent to those skilled in the art that various modifications and variations can be made to the disclosed print head and method. Other embodiments will be apparent to those skilled in the art from consideration of the specification and practice of the disclosed print head and method. It is intended that the specification and examples be considered as exemplary only, with a true scope being indicated by the following claims and their equivalents.

What is claimed is:

1. An additive manufacturing system, comprising:
a support;
a print head operatively connected to and moveable by the support, the print head including:
a supply module; and
a wetting module, including:
a body have an inlet configured to separately receive a reinforcement from the supply module and a matrix, and an outlet configured to discharge the reinforcement wetted with the matrix; and
a teasing mechanism disposed between the inlet and the outlet, the teasing mechanism having multiple operating positions configured to affect varying levels of pressure against the reinforcement.

2. The additive manufacturing system of claim 1, wherein the print head includes a matrix source configured to direct pressurized matrix into the wetting module.

3. The additive manufacturing system of claim 2, further including a pressure sensor associated with the wetting module and configured to generate a pressure signal indicative of a matrix pressure inside of the wetting module.

4. The additive manufacturing system of claim 3, further including a controller programmed to selectively adjust a pressure of the matrix source based on the pressure signal.

5. The additive manufacturing system of claim 4, wherein the controller is programmed to selectively adjust a pressure of air directed into the matrix source based on a pressure of matrix inside the wetting module.

6. The additive manufacturing system of claim 5, wherein the controller is further programmed to make a comparison of air pressure to matrix pressure and selectively determine a characteristic of the matrix based on the comparison.

7. The additive manufacturing system of claim 6, wherein the characteristic is a quality.

8. The additive manufacturing system of claim 7, further including a temperature sensor configured to detect a temperature of the matrix in the wetting module, wherein the controller is configured to determine the quality of the matrix based further on the temperature.

9. The additive manufacturing system of claim 8, further including a heater configured to heat the matrix in the wetting module.

10. The additive manufacturing system of claim 9, wherein the heater is located upstream of the temperature sensor.

11. The additive manufacturing system of claim 6, wherein the characteristic is a viscosity.

12. The additive manufacturing system of claim 5, wherein the controller is further programmed to make a comparison of air pressure to matrix pressure and selectively determine a determine a failure of the matrix source based on the comparison.

13. The additive manufacturing system of claim 1, wherein the teasing mechanism includes at least one roller configured to press the matrix through the reinforcement.

14. The additive manufacturing system of claim 13, wherein the teasing mechanism further includes a frame removeable from the wetting module and having a plurality of mounting positions for the at least one roller.

15. The additive manufacturing system of claim 13, wherein the at least one roller includes a plurality of rollers.

16. A method of additively manufacturing a structure, comprising:
pressurizing a matrix at a supply;
directing the pressurized matrix from the supply to an outlet that is remote from the supply;
detecting a pressure at the outlet;
adjusting a pressure at the supply based on the pressure at the outlet;
making a comparison of the pressure at the outlet to an expected pressure; and
determining a characteristic of the matrix based on the comparison.

17. The method of claim 15, wherein the characteristic is a viscosity.

18. The method of claim 16, wherein the characteristic is a quality.

19. The method of claim 18, further including sensing a temperature of the matrix at the outlet, wherein determining the quality includes determining the quality based further on the temperature.

20. The method of claim 16, further including determining a failure of the supply based on the comparison.
